(19) United States
(12) Patent Application Publication
(10) Pub. No.: US 2026/0241360 A1
(43) Pub. Date: Aug. 20, 2026

(54) METHOD FOR OPERATING, CONTROLLING AND/OR MONITORING A PLANT

(71) Applicant: BASF SE, Ludwigshafen am Rhein (DE)

(72) Inventor: Daniel Engel, Ludwigshafen am Rhein (DE)

(21) Appl. No.: 19/539,649

(22) Filed: Feb. 13, 2026

(30) Foreign Application Priority Data
Feb. 14, 2025 (EP) 25157860.5

(51) Int. Cl. B01J 19/00; G05B 13/02

(52) U.S. Cl. CPC B01J 19/0033; G05B 13/027; B01J 2219/00191

(57) ABSTRACT

The disclosure relates to methods, apparatuses, systems, and computer elements for operating a plant. The disclose may relate to trustworthy AI. The disclosure may contribute to the united nation's sustainable development goals of “good health and well-being”, “clean water and sanitation”, “industry, innovation, and infrastructure”, “responsible consumption and production”. The disclosed method may comprise: providing at least one operational data set for operating, controlling and/or monitoring a plant.

### CROSS-REFERENCE TO RELATED APPLICATION(S)

This application claims the benefit of priority of European Patent Application No. 25157860.5, filed Feb. 14, 2025, the disclosure of which is hereby incorporated by reference herein in its entirety.

### TECHNICAL FIELD

The following disclosure relates to methods, apparatuses, systems, and computer elements for operating, controlling and/or monitoring a plant. The following disclose may relate to trustworthy AI. The following disclosure may contribute to the united nation's sustainable development goals of “good health and well-being”, “clean water and sanitation”, “industry, innovation, and infrastructure”, “responsible consumption and production”.

### BACKGROUND

(Chemical) plants are highly complex facilities where various chemical processes take place controlled by a variety of (chemical) apparatuses. These processes may involve the handling, storage, and transformation of different chemicals (which may include hazardous, flammable and/or toxic chemicals). These processes may be carried out for instance at high temperatures and/or high pressures, safe and efficient controlling of which may involve operating several apparatuses in a precise chronological order. For safe and efficient operations, operators of chemical plants may rely on a set of strict procedures, guidelines, operation manuals, safety data sheets, and regulations imposed by authorities. These measures help mitigate risks associated with hazardous materials, protect the health and safety of personnel, and safeguard the environment.

### SUMMARY OF EMBODIMENTS OF THE DISCLOSURE

According to a first aspect a method for operating, controlling and/or monitoring a plant is disclosed. The method comprising: obtaining a query related to operating at least one chemical apparatus of the plant; obtaining, based on the query, at least one operation data set comprising data related to operating the at least one chemical apparatus; determining or obtaining identification data for identifying the at least one operation data set, based on the obtaining the at least one operation data set; determining at least one operational data set, the determining the at least one operational data set comprising: providing a task instruction, based on the query and the at least one operation data set, to at least one generative data-driven model, the at least one generative data-driven model having been trained on general purpose training data sets to generate at least one output data set related to operating the at least one chemical apparatus in response to obtaining the task instruction; and providing the at least one operational data set, wherein the at least one operational data set comprises the at least one output data set and the identification data for identifying the at least one operation data set.

Any disclosure, embodiments and examples described herein relate to the method, the aspects, e.g. system, apparatus, product, e.g. chemical product, and computer element lined out above and below. Advantageously, the benefits provided by any of the embodiments and examples may equally apply to all other embodiments and examples.

In a chemical production line (e.g. of a chemical plant) a plurality of chemical apparatuses may be interconnected, e.g. in a complex manner. Operating a chemical apparatus may involve operating a number of other apparatuses in a specific chronological order. For instance, operating a chemical reactor may involve controlling various parameters such as temperature (for instance involving e.g. operating a heat exchanger coupled to the reactor), pressure (for instance involving e.g. operating a compressor and/or pressure control valve coupled to the reactor), and flow rates (for instance involving e.g. operating a pump coupled to the reactor). Parameters may be measured using appropriate sensors during operation and may be displayed to an operator of the plant, so that the operator may decide on how to proceed with optimal operation and safety. Parameters such as temperature, pressure and flow rate e.g. in a chemical reactor may be interdependent, so that modifying one parameter may impact other parameters, e.g. reducing a temperature may involve regulating the pressure e.g. and/or flow rates (e.g. flow rates of reactants or products may be influenced e.g. by reaction kinetics, which in turn may be influenced by temperature and pressure). Thus, several different apparatuses (e.g. pumps, heaters, valves) coupled to the chemical apparatus may need to be operated in a precise chronological order to safely control a specific parameter. Hence, an operator may need to follow a large number (e.g. several hundred or thousands) of (e.g. interrelated) operational documentation such as manuals of different apparatuses, safety sheets, guidelines and/or regulations regarding the operation of the plant to ensure safe and efficient operation of the plant.

In the following, embodiments of the present disclosure will be outlined by ways of examples. It is to be understood that the present disclosure is not limited to said embodiments and/or examples. All terms and definitions used herein are understood broadly and have their general meaning if not indicated otherwise.

The methods, the apparatuses, the systems, the uses, the computer elements and other aspects disclosed herein provide an efficient, safe and reliable way for operating chemical plants. An operational data set or operation sequence data set may allow a plant operator to safely operate a plant (or a chemical apparatus of the plant) even in unfamiliar, uncommon or time-pressing situations and in compliance with applicable regulations. Human operators need to understand and intervene into decisions of machines, in particular in fields with high safety requirements and humans as domain experts. This disclosure allows for obtaining operational data sets in human interpretable data, that can be validated by a human operator and only after validation by the human operator used for operating a chemical plant. Further, an intervention and/or triggering using human interpretable data is enabled. Hence, this disclosure enables trustworthy AI.

According to a first example aspect, a method for operating a plant is disclosed, the method comprising: obtaining (e.g. from an operator, e.g. via a user interface) a query related to operating at least one chemical apparatus of the plant; obtaining (e.g. from a server providing a data base comprising e.g. a plurality of operation data sets), based on the query, at least one operation data set comprising data related to operating the at least one chemical apparatus; determining or obtaining (e.g. from a server providing identification data for identifying the at least one operation data set) identification data for identifying the at least one operation data set, based on the obtaining the at least one operation data set; determining at least one operational data set (e.g. being or comprising at least one operation sequence data set) the determining the at least one operational data set (or e.g. operation sequence data set) comprising: providing a task instruction, based on the query and the at least one operation data set, to at least one generative data-driven model, the at least one generative data-driven model having been trained to generate at least one output data set related to operating the at least one chemical apparatus in response to obtaining the task instruction; and providing (e.g. via a user interface, e.g. to the operator) the at least one operational data set (or the at least one operation sequence data set), wherein the at least one operational data set (or the at least one operation sequence data set) comprises the at least one output data set and the identification data for identifying the at least one operation data set.

The method or any step of the method may for instance be performed, carried-out, executed and/or controlled by an/the computing apparatus, for instance a server, a server cloud, a computer-system, or part thereof. The method may be computer-implemented. For instance, the method or some steps of the method may be performed and/or controlled by using at least one processor e.g. of an/the apparatus. need it to work with the new board and future activities.

Alternatively, the method according to any aspect may be performed, carried-out, executed and/or controlled by more than one apparatus, for instance a server cloud comprising at least two servers or a system of apparatus, e.g. a system comprising at least one server providing at least one data base comprising operation data sets, a server providing a data base comprising operation data embeddings (e.g. in form of a data structure comprising the operation data embeddings and associated identification data for identifying the corresponding operation data sets, at least one server providing a generative data-driven model, and an apparatus comprising means for carrying-out the respective steps of the method according to the first aspect.

Determining identification data for identifying the at least one operation data set may comprise determining an identifier for the at least one operation data set, e.g. by retrieving it from meta data associated with the operation data set or a respective operation data embedding, or determining it based on such metadata. Identification data for identifying the at least one operation data set may in particular not be generated using a/the generative data-driven model. Determining or obtaining identification data for identifying the at least one operation data set is in particular independent of the at least one generative data-driven model generating the at least one output data set, i.e. the at least one generative data-driven model generating the at least one output data set is not used in the determining or obtaining identification data for identifying the at least one operation data set. Identification data for identifying the at least one operation data set may be used by an operator to locate and/or study the associated at least one operation data set or a larger data set comprising the at least one operation data set, enabling an operator more efficient validation of the generated output data set. Identification data may be or comprise retrieval data.

Obtaining the at least one operation data set may comprise filtering a plurality of operation data sets (e.g. via a keyword search) to obtain a filtered plurality of operation data sets, which may then be used in identifying at least one operation data set, instead of the (e.g. whole) plurality of operation data sets. This may enhance the performance and accuracy of the identifying and/or retrieval of operation data sets. Obtaining or identifying the at least one operation data set may comprise performing a similarity search according to a similarity measure, for instance the at least one operation data set may be most similar to the query in relation to other operation data sets with respect to the similarity measure.

According to a second example aspect, an apparatus is disclosed, the apparatus comprising respective means for carrying out or performing the steps of the method according to the first aspect (and/or any embodiment or example and combinations thereof of the method). Additionally or alternatively the apparatus may comprise at least one processor and at least one memory storing instructions that, when executed by the at least one processor, cause the apparatus at least to carry out the steps of the method according to the first aspect (and/or any embodiment or example and combinations thereof of the method). Additionally or alternatively the apparatus may comprise circuitry (e.g. hardware-only circuitry, digital circuitry and/or a combination of hardware circuits and software) designed or configured to implement the functions for carrying out the steps of the method according to the first aspect (and/or any embodiment or example and combinations thereof of the method). Circuitry may be implemented in a chipset or a chip or an integrated circuit.

In particular in accordance with the second example aspect an apparatus is disclosed comprising: means (e.g. an obtainer or receiver) for obtaining a query related to operating at least one chemical apparatus of the plant; means (e.g. an obtainer or receiver) for obtaining, based on the query, at least one operation data set comprising data related to operating the at least one chemical apparatus; means (e.g. a determiner) for determining or obtaining (e.g. from a server providing identification data for identifying the at least one operation data set) identification data for identifying the at least one operation data set, based on the obtaining the at least one operation data set; means (e.g. a determiner) for determining at least one operation sequence data set, the determining the at least one operation sequence data set comprising: providing a task instruction, based on the query and the at least one operation data set, to at least one generative data-driven model, the at least one generative data-driven model having been trained to generate at least one output data set related to a sequence of operation steps for operating the at least one chemical apparatus in response to obtaining the task instruction; means (e.g. a provider or transmitter) for providing (e.g. via a user interface, e.g. to the operator) the at least one operation sequence data set, wherein the at least one operation sequence data set comprises the at least one output data set and the identification data for identifying the at least one operation data set.

The disclosed apparatus according to any aspect may be a module or a component for a device, for example a chip. Alternatively, the disclosed apparatus according to any aspect may be a device, for instance a server, server cloud, a personal computer or a user device. The disclosed apparatus according to any aspect may comprise only the disclosed components, for instance means, processor, memory, or may further comprise one or more additional components, such as a graphical user interface.

According to a third example aspect, a system for operating a chemical plant (e.g. to produce a chemical product) is disclosed, the system comprising an apparatus according to any aspect, a data base server providing at least one operation data set, the data base server being communicatively coupled to the apparatus, a server providing the at least one generative data-driven model, the server being communicatively coupled to the apparatus, together performing or carrying out at least the steps of the method according to the first aspect (and/or any embodiment or example and combinations thereof of the method), in particular the system further comprising a user device configured to receive the query from an operator and to display the operational data set.

According to a further example aspect, a use of an operational data set or operation sequence data set generated according to the method of the first aspect (and/or any embodiment or example and combinations thereof of the method), or by the apparatus of any aspect for displaying the operational data set to an operator of the chemical plant and/or for producing a chemical product.

According to a further example aspect, a computer element is disclosed, the computer element comprising instructions, which when executed by a processor or a computing apparatus perform or carry out the steps according to the methods or as defined by the apparatuses disclosed herein.

According to a further example aspect, an operation sequence data set is disclosed, the operation sequence data set being provided by performing the steps of the method according to the first aspect.

According to a further example aspect, an apparatus is disclosed, configured to perform and/or control or comprising respective means for performing and/or controlling the method according to any example aspect. According to a further example aspect, an apparatus is disclosed comprising at least one processor; and at least one memory storing instructions that, when executed by the at least one processor, cause the first apparatus at least to perform the method according to any example aspect.

According to a further example aspect, a computer program or computer program product is disclosed, the computer program or computer program product when executed by a processor causing an apparatus, for instance a server, to perform and/or control the actions of the method according the any aspect.

According to a further example aspect, a (e.g. tangible and/or non-transitory) computer readable storage medium is disclosed, the computer readable storage medium comprising a computer program, the computer program when executed by a processor causing an apparatus, for instance a server, to perform and/or control the actions of the method according the any aspect.

According to a further example aspect, a method for operating a plant is disclosed comprising: obtaining a query for obtaining at least one operation sequence data set; obtaining, based on the query, at least one operation data set comprising data related to the operation of the plant; determining the at least one operation sequence data set, the determining the at least one operation sequence data set comprising providing a task instruction, based on the query and the at least one operation data set, to at least one generative data-driven model, the at least one generative data-driven model having been trained to generate at least one output data set related to a sequence of operation steps for operation of the plant in response to obtaining the task instruction; and providing the at least one operation sequence data set, wherein the at least one operation sequence data set comprises the at least one output data set and identification data for identifying the at least one operation data set.

Any disclosure herein relating to any example aspect is to be understood to be equally disclosed with respect to any subject-matter according to the respective example aspect, e.g. relating to an apparatus, a method, or a computer program. Thus, for instance, the disclosure of a method step shall also be considered as a disclosure of means for performing and/or causing to perform the respective method step. Likewise, the disclosure of means for performing and/or causing to perform a method step shall also be considered as a disclosure of the method step itself. The same holds for any passage describing at least one processor; and at least one memory including instructions; the at least one memory and the instructions configured to, with the at least one processor, cause an apparatus at least to perform a step.

In the following example features and example embodiments of all aspects will be described in more detail.

According to an example embodiment of all aspects, the at least one operation sequence data set comprises at least a part of the at least one operation data set and/or retrieval data enabling retrieval of the at least one operation data set. This may further enhance, e.g. decrease the time needed for, the validation process by an operator, further enhancing safe and reliable operation of the plant.

According to an example embodiment of the method according to the first aspect, obtaining the at least one operation data set is or comprises: obtaining a plurality of operation data embeddings (e.g. from a data base providing operation data embeddings) of respective operation data sets comprising data related to operating the at least one chemical apparatus, wherein an operation data embedding comprises an embedding of the respective operation data set; embedding (e.g. using an embedding model) the query into an embedding space comprising the plurality of operation data embeddings; identifying at least one operation data embedding of the plurality of operation data embeddings, the at least one operation data embedding being closest to the embedded query in the embedding space with respect to a similarity measure; and obtaining (e.g. from a data base) the at least one operation data set as the at least one operation data set corresponding to the at least one operation data embedding.

Obtaining a plurality of operation data embeddings may comprise filtering a plurality of operation data embeddings (e.g. via a keyword search, e.g. in meta data associated with the operation data embeddings) to obtain a filtered plurality of operation data embeddings, which may then be used in the identifying at least one operation data embedding instead of the (e.g. whole) plurality of operation data embeddings. This may enhance the performance and accuracy of the identifying and/or retrieval of operation data sets and/or operation data embeddings.

This may allow for a time-efficient retrieval of relevant operation data sets and enhance stability or reliability of the retrieval process.

According to an example embodiment of the method according to the first aspect, determining or obtaining identification data for identifying the at least one operation data set, comprises obtaining a mapping between the at least one operation data set and the at least one corresponding operation data embedding, and determining or obtaining the identification data for identifying the at least one operation data set based on the mapping. A mapping between the at least one operation data set and the at least one corresponding operation data embedding may e.g. by comprised in meta data associated with the obtained at least one data set or it may e.g. be organized in a table provided by a data base server, e.g. a server providing the operation data embeddings.

According to an example embodiment of the method according to the first aspect, the method further comprises: operating and/or controlling the plant based on the at least one operation sequence data set, in particular to produce a chemical product.

An operator may e.g. obtain the at least one operation sequence data set, for instance via a user interface of an/the apparatus or a user interface of a user device connected to the apparatus, wherein the apparatus may comprise at least a determiner carrying out at least the determining steps of the method according to the first aspect. Such a user interface may be a graphical user interface configured to display at least part of the operation sequence data set.

According to an example embodiment of all aspects, the task instruction comprises an indication of the at least one operation data set and/or at least a part of the at least one operation data set. Preferably, the task instruction comprises the at least one obtained operation data set, e.g. as context data or context information for the generative data-driven model, which may enhance e.g. the accuracy of the generated output data set.

According to an example embodiment of the method according to the first aspect, obtaining the at least one operation data set is based on a retrieval score of the at least one operation data set, the method comprising at least one (preferably at least two) of (i), (ii), and (iii): (i) obtaining a plurality of operation data embeddings of respective operation data sets comprising data related to operating the at least one chemical apparatus, wherein an operation data embedding comprises an embedding of the respective operation data set; embedding the query into an embedding space comprising the plurality of operation data embeddings; determining a similarity score for the at least one operation data embedding of the plurality of operation data embeddings, wherein the similarity score is based on the distance between the at least one operation data embedding and the embedded query in the embedding space with respect to a similarity measure; determining the retrieval score based on the similarity score; (ii) obtaining a plurality of operation data sets; determining whether the query comprises at least one element related to the operation (e.g. related to handling a chemical or a chemical apparatus) of the plant (e.g. an element may be a term representative of a chemical apparatus or chemical used in the plant); upon determining that the query comprises at least one element related to the operation of the plant: Determining for each of the plurality of operation data sets a keyword score based on the number of elements related to the same operation of the plant in each of the plurality of operation data sets; determining the retrieval score based on the keyword score; (iii) Determining at least one context data set for the query; obtaining a plurality of operation data sets, wherein the at least one operation data set is included in the plurality of operation data sets and is associated with at least one context data set; determining a context score for the at least one operation data set of the plurality of operation data sets based on the number of context output data sets shared between the at least one operation data set and the query; and determining the retrieval score based on the context score.

Determining a similarity score for the at least one operation data embedding of the plurality of operation data embeddings, wherein the similarity score is based on the distance between the at least one operation data embedding and the embedded query in the embedding space with respect to a similarity measure may e.g. comprise determining a similarity score for (essentially) each of the plurality of operation data embeddings.

Determining for each of the plurality of operation data sets a keyword score based on the number of elements related to the same operation of the plant in each of the plurality of operation data sets may e.g. comprise using a bag-of-words retrieval function (e.g. BM25, BM25F, BM25+) that ranks a set of operation data sets based on the number of elements related to the same operation of the plant appearing in each operation data set, e.g. regardless of their proximity within the operation data set. For instance, given a query Q comprising a number of elements related to the same operation of the plant qᵢ (e.g. keyword) the keyword score may be implemented as:

$$keyword\_score ( Q , O ) = {\sum }_{i = 1}^{n} IDF ( {q}_{i} ) \cdot \frac{f ( {q}_{i} , O ) \cdot ( {k}_{1} + 1 )}{f ( {q}_{i} , O ) + {k}_{1} \cdot ( 1 - b + b \frac{\vert O \vert}{a v g s} )} .$$

wherein f(qᵢ,O) may be the number of times that qᵢ appears in the operation data set O, |O| may be the size of the operation data set O (e.g. Length of a document in words), and avgs may be the average size of an operation data set (e.g. average document length of documents stored in a database of operation data sets, when chunked to a certain length this may correspond to the chunk length, e.g. 250 words), kᵢ∈[1.2, 2.0], b=0.75·IDF(qᵢ), wherein IDF(qᵢ) may be the inverse document frequency weight of qᵢ, which may be given by:

$$IDF ( {q}_{i} ) = ln ( \frac{N - n ( {q}_{i} ) + 0.5}{n ( {q}_{i} ) + 0.5} + 1 ) ,$$

wherein N may be the total number of operation data sets in the database/plurality of operation data sets, and n(qᵢ) may be the number of operation data sets containing qᵢ.

Determining a context score for the at least one operation data set may e.g. comprise determining whether the query comprises at least one element related to the context data set; Upon determining the query comprises at least one element related to the context data set: Associating the query with the context data set.

Determining a context score for the at least one operation data set may e.g. comprise, determining a context score for (essentially) each of the plurality of operation data sets.

Preferably the retrieval score is based on a weighted average of the similarity score, the keyword score, and the context score.

Preferably, obtaining the at least one operation data set is based on a retrieval score of the at least one operation data set comprises obtaining the at least one operation data set associated with the highest retrieval score or obtaining (e.g. retrieving) the at least one operation data set associated with a retrieval score being below or above a threshold retrieval score. For instance, the at least one operation data set may comprise all operation data sets associated with a retrieval score of more than 0.7 (e.g. when the retrieval score reaches from 0 to 1).

According to an example embodiment of the method according to the first aspect, obtaining the at least one operation data set is based on a retrieval score of the at least one operation data set, the method comprising: determining a similarity score between the query and at least one operation data set based on a similarity measure between an embedding of the query and an embedding of the at least one operation data set in an embedding space; determining the retrieval score based on the similarity score; determining whether the query and the at least one operation data set are associated with at least one same context data set; and upon determining that the query and the at least one operation data set are associated with at least one same context data set, determining a score increase based on the number of same context output data sets, wherein the retrieval score is based on the similarity score increased by the score increase.

This may for instance comprise determining a similarity score d_i between the query q and at least one operation data set c_i may be based on a similarity measure d_i=cos (q, c_i); determining a retrieval score based on the similarity score; determining whether the query and the at least one operation data set are associated with at least one same context data set; and upon determining that the query q and the at least one operation data set c_i are associated with at least one same context data set, determining a score increase (e.g. 20 or 30%) based on the number of same context data sets, wherein the retrieval score is based on the similarity score increased by the score increase. For instance, if at least one context data set shared between query and operation data set increase score by 20% or 30%, otherwise do not increase score; or for each context data set shared between query and operation data set increase score by e.g. 20%. This weighing may enhance retrieval of relevant operation data sets.

According to an example embodiment of the method according to the first aspect, obtaining the at least one operation data set comprising: determining whether the query and the at least one operation data set are associated with (e.g. only) different context data sets (or the query and the at least one operation data set are not associated with a same context data set); and upon determining that the query and the at least one operation data set are associated with (e.g. only) different context data sets (or the query and the at least one operation data set are not associated with a same context data set), not obtaining the at least one operation data set. This may e.g. be used to filter operation data sets not related to the query, if this is done before obtaining the plurality of operation data sets or operation data embeddings e.g. for determining a retrieval score, computer resources may be saved.

According to an example embodiment of all aspects, the generative data-driven model is or comprises a multimodal generative data-driven model.

According to an example embodiment, the at least one operation data set comprises one or more two-dimensional operation representation specific to at least one chemical or industrial process for producing a product, in particular a chemical product. For instance an industrial process carried out in a plant may be operated, monitored and/or controlled to in particular produce the product. An operation representation may include at least one structured representation of at least one diagram with graphical symbols specific to the chemical and/or industrial process, wherein the graphical symbols are pre-defined and represent process components of the chemical and/or industrial process. An operation representation may comprise one or more graphical representations including pre-defined graphical elements associated with components or assets of the chemical or industrial process, such as a chemical apparatus or other apparatus of a plant. An operation representation may include at least one process and instrumentation diagram (P&ID), process flow diagram (PFD), a three dimensional (3D) representations of the physical layout of the industrial or chemical process, an operational measurement representation based on or from measurement and/or control components, measurement representations based on sensor layouts signifying sensor positions in relation to chemical apparatuses, piping and/or equipment of the industrial or chemical process. Such graphical symbols may be pre-defined according to a standard such as ANSI/ISA 5.1-2024, ISO 10628-1:2014 and/or ISO 14617-1:2005.

The operation representation may comprise two-dimensional floor plans and/or cross-sections of the plant, showing e.g. two-dimensional views indicating the locations of access points to specific chemical apparatus or equipment. It may also comprise control loop diagrams, image data on chemical apparatuses, control panels, concept drawings, and other technical diagrams.

Furthermore, a/the multimodal generative data-driven model may be used to generate textual descriptions (in particular in natural language) of the operation representation(s), which may be embedded into the embedding space as or as part of respective operation data embeddings(s). For instance, the method according to the first aspect may comprise: Determining at least one textural description or natural language data set related to an operation representation comprised by an operation data set based on or by providing a task instruction, e.g. based on pre-prepared template task instruction, comprising or indicating the operation representation to at least one multimodal generative data-driven model, the at least one multimodal generative data-driven model having been trained on general purpose training data sets to generate at least one textural description or natural language data set in response to obtaining the task instruction; and embedding the at least one textural description or natural language data set, e.g. by including or attaching the at least one textural description or natural language data set to the operation data set comprising the operation representation into an enriched operation data set or by replacing the operation representation by the at least one textural description or natural language data set in the operation data set into an enriched operation data set; and then embedding the enriched operation data set into the embedding space as an operation data embedding e.g. for later determining a similarity score based on which the respective operation data set may be obtained. The operation data set and the respective operation data embedding may e.g. be connected via metadata attached to the operation data set. An enriched operation data set may be used in a hybrid search like an operation data set. For instance, a similarity score, a keyword score and/or a context score may be determined based on the enriched operation data set for later determining a similarity score based on which the respective operation data set may be obtained, which may enable enhanced retrieval of operation representations including e.g. image data related to specific machinery such as a chemical apparatus, layout plans, or technical drawings, which may enhance e.g. effective control, operation and monitoring of the plant or the industrial or chemical process carried out in the plant, which may increase efficiency and safety e.g. with faster real-time adjustments and monitoring facilitated by the operation representation or reducing downtime of the plant. As an example, the at least one operation data set may be associated with at least one enriched operation data set comprising or being associated with at least one description or natural language data set related to the one or more operation representation(s), wherein obtaining the at least one operation data set may be based on the at least one enriched operation data set. The at least one description or natural language data set related to the operation representation may be or may have been generated by providing a describe task instruction comprising or indicating the one or more operation representation(s) to the at least one multimodal generative data-driven model or another multimodal generative data-driven model, the describe task instruction may comprise or indicate an instruction for the at least one multimodal generative data-driven model or the other multimodal generative data-driven model to generate at least one description or natural language data set for the one or more operation representation(s). In the at least one enriched operation data set the one ore more operation representation(s) may have been or may be replaced with (the) at least one description or natural language data set.

In an example of the method according to the first aspect, obtaining the at least one operation data set may be based on a retrieval score of the at least one operation data set, the example method comprising one or more of (i), (ii), or (iii): (i) obtaining a plurality of operation data embeddings of respective operation data sets comprising data related to operating the at least one chemical apparatus, wherein in particular at least one operation data set comprises one or more two-dimensional operation representation(s), wherein an operation data embedding of the at least one operation data set comprising the one or more two-dimensional operation representation(s) comprises an embedding of the respective at least one enriched operation data set; embedding the query into an embedding space comprising the plurality of operation data embeddings; determining a similarity score for the at least one operation data embedding of the plurality of operation data embeddings, wherein the similarity score is based on the distance between the at least one operation data embedding and the embedded query in the embedding space with respect to a similarity measure; determining the retrieval score based on the similarity score; (ii) obtaining a plurality of operation data sets; determining whether the query comprises at least one element related to the operation of the plant; upon determining that the query comprises at least one element related to the operation of the plant: determining for each of the plurality of operation data sets a keyword score based on the number of elements related to the same operation of the plant in each of the plurality of operation data sets and/or in the at least one enriched operation data set(s) (e.g. in each of a plurality of operation data sets, wherein at least one operation data set comprising one or more two-dimensional operation representation(s) has been replaced with at least one respective enriched operation data set for the purpose of determining the retrieval score); determining the retrieval score based on the keyword score; (iii) determining at least one context data set for the query; Obtaining a plurality of operation data sets, wherein the at least one operation data set is included in the plurality of operation data sets and is associated with at least one context data set; determining a context score for the at least one operation data set based on a number of context data sets shared between the at least one operation data set and the query; and determining the retrieval score based on the context score.

A Process Flow Diagram (PFD) may describe the relationships between major components (e.g. chemical apparatuses) in an industrial or chemical process, it may however dispense with describing minor components, piping systems, or instrumentation. A PFD may focus on the flow of chemical fluids and the equipment involved in the process, highlighting some properties such as temperature, pressure, fluid density, and flow rate. A PFD may give a broad overview of the production process and may be updated e.g. if equipment or material flows are changed or meant to be changed. A Piping and Instrumentation Diagram (P&ID) may include more detailed information than a PFD. It may describe major equipment, piping details (such as service, size, specification, and rating), and instrumentation details (such as pressure, temperature, and flow instruments). The P&ID may e.g. include control valves, safety valves, and other minor components. A P&ID may provide detailed information allowing operation of the industrial process, e.g. to produce a chemical product. PFDs and P&IDs may be examples of graphical representations of at least a part of the industrial process.

According to an example embodiment, the at least one operation data set comprises one or more textual data sets associated with the one or more two-dimensional operation representation, e.g. a description, a bill of material or the like. This way multiple data types may be used which may increase reliability in generating operational data sets. Since these operation representations are used for operating a plant or process, reliability can be increase by using different data sources as input in this safety and industrial process performance relevant field.

For example, the one or more two-dimensional operation representation comprises at least one structured representation of at least one diagram with graphical symbols representing at least the at least one chemical apparatus. For example, the at least one operation data set comprises one or more two-dimensional operation representation specific to at least one chemical or industrial process, in particular a chemical or industrial process to be controlled, monitored and/or operated to produce a chemical product.

According to an embodiment, the at least one operation data set comprises a pre-prepared mapping between graphical symbols and a chemical apparatus, the other apparatus, or the chemical.

For example, the at least one operation data set may comprise an identifier of a chemical apparatus or process, wherein the identifier may be comprised in a two-dimensional representation as text.

According to an example embodiment of all aspects, the task instruction comprises an instruction to validate the query and/or the at least one output data set. An instruction to validate the query may enhance a generative data-driven model's ability to identify whether a query did not correspond to a recognized operation of the plant, so that the output data set may e.g. comprise a respective warning for e.g. notifying the operator. An instruction to validate the at least one output data set may allow for increased accuracy and/or understandability of the generated output data set, e.g. the generated output data set may comprise reasoning steps and/or it may enhance the generative data-driven models ability to generate an output data set from complex task instructions. An instruction to validate may e.g. correspond to chain-of-though prompting, e.g. the instruction may instruct the generative data-driven model to generate its output step-by-step.

According to an example embodiment of all aspects, the task instruction comprises at least one of the following (including combinations of): an instruction to include a citation of the at least one operation data set in the at least one output data set; an instruction to include information data on safety risks and/or pitfalls related to the operating the at least one chemical apparatus.

According to an example embodiment of the method according to the first aspect, the query comprises natural language, comprising a number of terms, and at least one term (such as a designation of the apparatus or an identifier) associated with the chemical apparatus or another apparatus in the query is replaced or expanded using a pre-prepared mapping of the term to further information data on the chemical apparatus or the other apparatus resulting in a pre-processed query; and wherein the obtaining the at least one operation data set is based on the pre-processed query; and wherein the providing the task instruction is based on the pre-processed query. Pre-processing the query and/or operation data sets may enhance the accuracy of operation data sets obtained for a given query. A pre-prepared mapping of the term to further information data on the chemical apparatus, the other apparatus or a chemical may be a table or other data structure configured to associate an element, such as the term, with other elements, e.g. other terms. A pre-prepared mapping may for instance be an equipment mapping, a chemical mapping, and/or an asset table. A pre-processed query may enhance accuracy and reliability of the obtaining of operation data sets and/or operation data embeddings, it may e.g. enhance filtering a plurality of operation data sets and/or operation data embeddings and avoid missing operation data sets and/or operation data embeddings comprising e.g. a different associated term for the same chemical apparatus. Replacing or expanding a term (such as a designation of the apparatus or an identifier) may comprise obtaining (e.g. receiving, for example receiving from a server or retrieving from a memory) a pre-prepared mapping of the term to further information data on the chemical apparatus or the other apparatus; identifying data associated with the term in the mapping; replacing the term with at least part of the identified data (e.g. another term, designation, identifier for the chemical apparatus or another apparatus) or expanding the term by concatenating at least part of the identified data (e.g. another term, designation, identifier for the chemical apparatus or another apparatus) to the term.

According to an example embodiment of all aspects, the at least one operation data set is a part of a larger data set, and wherein the at least one operation data set comprises a part of another operation data set. This may allow for different operation data sets to overlap, e.g. by up to 10 percent, allowing or enhancing merging operation data sets, e.g. in case different operation data sets comprise parts of a procedure or other sequential data, so that e.g. the time-order of procedure steps may be preserved in a context data provided to the generative data-driven model.

According to an example embodiment of the method according to the first aspect, the method further comprises: determining whether the operation data set is a part of a larger data set; upon determining that the operation data set is a part of a larger data set: obtaining the position of the part relative to at least one other operation data set that is another part of the larger data set; combining the part with the at least one other operation data set according to the position into a combined data set; wherein the determining the task instruction based on the query and the at least one operation data set is based on the combined data set.

According to an example embodiment of all aspects, the at least one operational data set comprises at least one operation sequence data set, and wherein the at least one output data set being related to a sequence of operation steps for operating the at least one chemical apparatus.

In an example embodiment, the at least one (e.g. one or more) generative data-driven model may be a pretrained generative data-driven model. The pretrained generative data-driven model(s) may be parametrized and/or trained based on data with a plurality of contexts and/or natural language data or unstructured data, in particular text data and optionally numerical data such as tabular data or image data. The pretrained generative data-driven model(s) may be configured to perform a plurality of task and/to process data of a plurality of contexts and/or general purpose training data. The pretrained generative data-driven model(s) may be configured to perform the task according to the provided task instruction. Hence, the pretrained data-driven model may be configured to be provided with a plurality of different task instructions and/or provide a plurality of different types of output data upon receiving different task instructions. By using a pretrained model, readily available models can be utilized for generating processed production and/or processing data, while the data-driven model may be deployed for other applications as well. Thereby, resources for hosting the generative data-driven model can be shared among a plurality of applications. In an example embodiment, the at least one generative data-driven model(s) may be finetuned generative data-driven model(s). The finetuned generative data-driven model(s) may be obtained by training pretrained data-driven model(s) configured to perform a plurality of tasks according to a plurality of task instructions. The finetuned generative data-driven model(s) may trained additionally on a training data set comprising a plurality of historical contextualized task instructions and corresponding processed production and/or processing data. The finetuned generative data-driven model may be configured to be provided with a plurality of different task instructions and/or provide a plurality of different types of output data upon receiving different types of task instructions. Further, the finetuned generative data-driven model may be configured for providing one type of output upon receiving one type of task instruction with a higher accuracy than providing other types of output data upon receiving other types of task instructions.

According to an example embodiment of all aspects, the generative data-driven model is a fine-tuned generative data-driven model, wherein the fine-tuned generative data-driven model is a general-purpose generative data-driven model that has been further trained using a plurality of plant operation specific queries associated with pre-determined output data sets. A general-purpose generative data-driven model (such as Llama, Llama 2, Llama 3, Mistral 7B, Mixtral 8x7B, or Mixtral 8x22B, Mamba) may have been (pre-) trained using a large number of training data sets, which may be unlabeled data sets, in an unsupervised manner. The pre-trained generative data-driven model may then be fine-tuned using for example a number of labeled plant operation specific training data sets, comprising queries and respective (correct) output data sets. Preferably, low-rank adaptation or parameter-efficient fine-tuning (PEFT) is used for fine-tuning 420, which may allow for efficient fine-tuning and may reduce the risk of the pre-trained general purpose generative data-driven model losing the pre-trained weights (i.e. catastrophic forgetting). The fine-tuning may involve creating a number of training queries, e.g. by consulting operators on likely queries or using a generative data-driven model to generate queries, wherein an operator is included as a production persona in a prompt for generating the training queries, which may enhance the quality of the output. Operation sequence data sets may then be generated based on the trained queries using the pre-trained general purpose generative data-driven model. The operation sequence data sets may then be corrected e.g. by consulting respective experts for the operation of the plant and the corrected operation sequence data sets may be used as labels of the respective training queries. The labeled training queries may be used for fine-tuning the generative data-driven model.

According to an example embodiment of all aspects, a size of a part is predefined to be below an input size limit for the generative data-driven model.

According to an example embodiment of all aspects, the operation data sets (e.g. stored in a database) are associated with one or more of the following: chemical apparatus or chemical unit operations, safety requirements and training procedures.

In an embodiment, the (e.g. unstructured) query, the task instruction, the output data set, the operational data set and/or the operation sequence data set may include string data and/or a sequence of one or more elements such as terms. An element or term may comprise a number, a letter, a symbol or the like.

A generative data-driven model may be a model, e.g. implemented in a computer system, that, based on historical data it has been trained on, may generate new instances of said data e.g. by sampling from a probability distribution, wherein the probability distribution may have been learned during training, and generate an according output data set after receiving a task instruction. A generative data-driven model may have been trained on general purpose training data sets (and e.g. via that training may be configured to) to generate an output data set in response to obtaining (e.g. receiving) the task instruction. A generative data-driven model may be or comprise a transformer-based data driven model, preferably a decoder-only transformer-based model such as a generative pre-trained transformer, e.g. Large Language Model Meta AI (Llama), Llama 2, Llama 3, Mistral 7B, GPT 3.5, GPT 3.5 turbo, GPT 4, GPT 4o. A generative data-driven model may be or comprise a mixture of experts architecture-based model e.g. Mixtral 8x7B, Mixtral 8x22B. In a mixture of experts model several decoder blocks may be operated in parallel representing different experts or a feed-forward layer in a block may be split into separate parallel feed-forward layer, wherein each of the parallel feed-forward layers may be regarded as an expert and may learn to focus on different tasks during training. A gating network may be used to switch a particular input to the respective expert, e.g. by training the gateway network alongside the experts for instance using an expectation-maximization algorithm or a gradient descent algorithm. A generative data-driven model may be or comprise a selective state space sequence architecture based model e.g. Mamba. A generative data-driven model may be or comprise a combined architecture such as Mamba LLM or Mamba Mixture of Experts (which may comprise alternating Mamba and mixture of experts layers). A selective or structured state space sequence architecture (e.g. SSMs, S4, or S6 models) may allow for using more context in generation and allow for generating larger output data sets.

For instance, when receiving a task instruction the generative data-driven model may process the task instruction. For instance, the (received) task instruction may be tokenized, e.g. by dividing the task instruction into tokens (i.e. smaller units), such as words or subwords. The task instruction or tokens of the task instruction may be embedded e.g. converted into a vector in the model's latent space, e.g. by an embedding layer of the generative data-driven model.

A generative data-driven model may be or comprise an artificial neural network (ANN), which may comprise several layers.

A generative data-driven model may comprise an embedding layer for embedding a received token into the model's latent space, which may be a numerical representation or vector of the token in the latent space.

The generative data-driven model may comprise a positional encoding layer, which may encode the position of a received token relative to the task instruction. For instance, using trigonometric functions such as sine and cosine a unique positional encoding vector for each position of a token in the task instruction may be generated. The positional encoding vector may then be added element-wise to the embedding of the token obtained by an embedding layer, so that the position of the token is encoded together with the embedding of the token in the embedded token passed to e.g. an encoder or decoder block.

A generative data-driven model may comprise one or more encoder layers forming an encoder block and/or one or more decoder layers forming a decoder block.

A decoder and/or encoder block may comprise a self-attention layer. A self-attention layer may be configured to (re-)encode an embedded token (e.g. a vector) by taking into account the context provided by all other tokens. A self-attention layer may be configured to weigh the relevance of different parts (i.e. tokens) of its input with regard to the (e.g. overall) input. The input of a self-attention layer may have the form of a matrix (e.g. input matrix) or tensor, in which each row or column may correspond to an embedded token, which may be a vector, The output of a self-attention layer may then also be a matrix (e.g. output matrix) or tensor, wherein each row or column may additionally contain information on the relevance of the token relative to the other tokens. For instance, the first self-attention layer may be configured to weigh the relevance of different tokens of a task instruction based on their relevance to the (e.g. overall) task instruction, where the overall task instruction may be represented as the matrix of all embedded tokens of the task instruction. In this case the input matrix for the first self-attention layer e.g. after an input layer, may comprise the embedded tokens of the task instruction, i.e. vector representations of each token of the task instruction. To determine the self-attention, an individual embedded token (e.g. a token vector or row/column vector of the input matrix) may be transformed into a set of vectors (e.g. also named a head) namely a query vector, a key vector, and a value vector by e.g. Linear projection, such as multiplying a token vector by a respective weight matrix. Then a scaled dot-product attention may be applied, e.g. by forming the dot-product of each query vector with each key vector to calculate an attention score that may represent the relevance of a given token relative to the (e.g. overall) input of the self-attention layer, e.g. In particular for the first self-attention layer the relevance of the token to the task instruction. The attention scores may then be normalized using a softmax function, which converts each attention score into a respective softmax score, which may represent probabilities that sum up to 1, so that e.g. the weight of higher attention scores is increased and the weight of lower attention scores is decreased. Then, each value vector may be multiplied by the respective softmax score to calculate a weighted value vector. The weighted value vectors—corresponding to the tokens of the task instruction—may then be summed up to determine a self-attention vector. The output matrix of the self-attention layer may then comprise the self-attention vectors. The self-attention layer may also utilize several sets of trained vectors (or heads) each comprising a query vector, a key vector, and a value vector. In this case, the output matrices resulting from calculating the self-attention of each head may be concatenated and multiplied by an additional trained weight matrix, which may allow to transform the matrix to the dimensions of the input matrix, the resulting matrix may correspond to the output matrix of the self-attention layer. This multi-head approach to self-attention may allow the self-attention layer to capture different types of information from the input matrix in each of the heads. For example, one head might focus on syntactic information, another on semantic information.

A decoder and/or encoder block may comprise at least one feed-forward layer, which may perform at least one linear transformation, preferably two linear transformation, wherein a Rectified Linear Unit activation function is applied between the two linear transformations.

A decoder block may comprise a cross-attention layer. For instance, similar to the self-attention layer an attention score between different data sets may be calculated. For example, a query vector may be determined based on tokens from the task instruction like in self-attention, whereas the key and value vectors may be determined based on context information, e.g. provided separately, which may e.g. be part of an operation data set.

A generative data-driven model may comprise an output layer, which may e.g. be configured to determine a probability distribution for the next token of an output sequence, e.g. which may be or be comprised by the output data set or the operational data set or operation sequence data set. For instance, the output matrix of the last decoder block may be linearly transformed to e.g. a vocabulary size (which may be larger than the size of the corresponding dimension of the output matrix) and a softmax function may be applied to create a probability distribution, e.g. over the vocabulary. From this distribution a sampling module may sample the next token of the output sequence, e.g. by selecting the token having the highest probability or by selecting the k tokens with the highest probability and selecting one from the k tokens at random. The sampling module may use top k-sampling or top p-sampling. The output sequence generated may then be attached to the prompt and again processed by the generative data-driven model to determine the next token and so forth until a end token is generated or a maximum length threshold is reached, wherein the end token may have been trained during training.

The generative data-driven model may be a (pre-)trained or parametrized general purpose model parametrized or trained based on general data sets including input-output-data pairs not specific to input data related to the operation of the plant.

An operation sequence data set, operational data set and/or an output data set of the generative data-driven model comprises data related to operating the at least one chemical apparatus. An operational data set may comprise data related to handling a chemical used in the chemical plant, e.g. for producing a chemical product, data related to conducting maintenance on the chemical plant or a chemical apparatus of the plant, data related to safety of the chemical plant or chemical apparatus. An operational data set may e.g. be an operation sequence data set.

An operation sequence data set and/or an output data set may be a data set comprising data on how a chemical apparatus and/or a plant comprising the chemical apparatus is to be operated, e.g. a sequence of steps an operator should follow to ensure safe and compliant operation of the plant or a chemical apparatus of the plant. It may comprise data related to e.g. a sequential or ordered collection of operations or steps performed within a process or system. An operation sequence data set may comprise an output data set generated by a generative data-driven model. For instance, it may contain instructions on how to operate a chemical (production) apparatus, such as a chemical reactor. Operation of a chemical apparatus may be an operation for producing a chemical product or an operation for conducting maintenance on the chemical apparatus. Such instructions my comprise information data on operating the chemical apparatus or another apparatus that is in a functional relationship with the chemical apparatus. For instance, it may comprise an instruction to close a valve before reducing a temperature in a chemical reactor. An output data set and/or an operation sequence data set may comprise information data from several different operation data sets, for instance it may comprise a chronological sequence of operation steps, wherein the different operation steps may be described in different operation data sets. For example, the output data set and/or operation sequence data set may comprise a time-sequence of process steps to be followed for an efficient and safe operation of the plant or a chemical apparatus of the plant. For instance, an operation data set may comprise operation instructions on how to shut down a chemical apparatus, which may e.g. mention regulating another chemical apparatus described in a different operation data set, and the output data set and/or operation sequence data set may comprise the time-sequence taking into account information data from both the operation data set and the other operation data set in the correct time order. The output data set and/or the operation sequence data set may comprise further information data, such as information data on safety risks and/or pitfalls that may e.g. be found in an operation data set, and/or information data on an operation data set used in generating an output data set. The output data set and/or the operation sequence data set may be in human understandable format, it may e.g. consist of or comprise natural language. The operation sequence data set may comprise the output data set generated by a generative data-driven model.

A plant may be a chemical production facility, that may comprise at least one chemical production line for producing a chemical product or material. A chemical plant may utilize chemical apparatuses, e.g. equipment and machinery to transform raw materials and/or chemicals through various physical and chemical methods into a chemical product. The operations in a chemical plant may include chemical reactions, distillations, separations, purifications, as well as packaging. Chemical products produced by a chemical plant or chemical production line may be basic chemicals, petrochemicals, agrochemicals, polymers and/or pharmaceuticals. Safety and environmental impact are significant considerations in the operation of a chemical plant.

An industrial process operation system (IPOS) may be or comprise a computing system configured to carry out at least a part of the disclosed method, e.g. the method according to the first aspect. An IPOS may receive data from a control system of a plant e.g. via a process information system.

A query may be a request e.g. from an operator of a chemical plant for information on how to operate the chemical plant or a part of the chemical plant such as a chemical apparatus. A query may be provided in natural language and may be present in or comprise unstructured data. A query may be a question to extract specific information data on the safe operation of a chemical plant satisfying (e.g. all) relevant requirements set e.g. by guidelines, safety instructions, or regulatory authorities.

An operation data set may be a data set related to the operation of a plant. An operation data set may comprise at least a part of a operational documentation such as a procedure, guideline, operation manual, safety data sheet, or a regulation imposed by authorities. An operation data set may be or comprise an operational data set e.g. comprise at least a part of at least one of the following (including combinations of): a manual on operating the plant, a safety sheet, a log file from past operation of the plant, an operating procedure, a maintenance procedure, a maintenance log, a safety procedure, a standard guideline, a technical rule set, an Environment, Health, and Safety (EHS) rule or policy, a service manual, a manual provided by an original equipment manufacturer, a quality management manual, a shift log, a material specification, a safety instruction system specification, an instrument data sheet, operator training material and the like. A manual may e.g. comprise step-by-step instructions for operating chemical apparatus or equipment, starting up and shutting down processes, handling emergencies, and/or troubleshooting. A safety data sheet may provide detailed information data on the properties, hazards, and safe handling practices for a chemical or a chemical apparatus used in the plant. Regulations may comprise mandatory standards for chemical plants and relate to the protection of employees, the environment, and the public. These regulations may relate to areas such as process safety management, hazard communication, personal protective equipment, and emergency response planning. Logs may comprise day-to-day data related to a plant operation, it may e.g. comprise a time stamp, and may comprise a historical record of operating the plant or chemical apparatus.

A chemical apparatus may be an apparatus, device, or equipment used in a chemical plant, e.g. in a chemical production process or production line. For instance, a chemical apparatus may be a part of a chemical production line. A chemical apparatus may e.g. be a heater, cooler, heat exchanger, pump, compressor, pressure valve, a chemical reactor, a column such as a fractionating column, a furnace, a reaction chamber, a cracking unit, a storage tank, an extruder, a pelletizer, a precipitator, a blender, a mixer, a cutter, a curing tube, a vaporizer, a filter, a stack, an actuator, a mill, a transformer, a conveying system, a circuit breaker, a machinery e.g., a heavy duty rotating equipment such as a turbine, a generator, a pulverizer, a transport element such as a conveyor system, or a motor. A chemical apparatus, a production line and/or a plant may comprise at least one sensor (e.g. a plurality of sensors) and at least one control system for controlling at least one parameter related to a production process, or process parameter, e.g. in the plant. A control functions may be performed by the control system or controller in response to at least one measurement signal from at least one of the sensors. The controller or control system of the plant may be implemented as a distributed control system, DCS, and/or a programmable logic controller, PLC. The sensors may be distributed in a production line or a plant, e.g. a distributed production environment, for monitoring and/or controlling purposes. Sensors may generate a large amount of data. The sensors may or may not be a part of a chemical apparatus or equipment. Sensors may be used for measuring one or more process parameters and/or for measuring operating conditions of a chemical apparatus or equipment or parameters related to the chemical apparatus or equipment or the process units. For example, the sensors may be used for measuring a process parameter such as a flowrate within a pipeline, a level inside a tank, a temperature of a furnace, a chemical composition of a gas, etc., and some sensors may be used for measuring vibration of a pulverizer, a speed of a fan, an opening of a valve, a corrosion of a pipeline, a voltage across a transformer, etc. The difference between these sensors cannot only be based on the parameter that they sense, but it may even be the sensing principle that the respective sensor uses. Some examples of sensors based on the parameter that they sense may comprise: temperature sensors, pressure sensors, radiation sensors such as light sensors, flow sensors, vibration sensors, displacement sensors and chemical sensors, such as those for detecting a specific matter such as a gas. Examples of sensors that differ in terms of the sensing principle that they employ may for example be: piezoelectric sensors, piezoresistive sensors, thermocouples, impedance sensors such as capacitive sensors and resistive sensors, and so forth. Sensor data obtained by the at least one sensor of a chemical apparatus, a production line and/or a plant may be part of an operation data set, e.g. as part of a log file.

A product produced e.g. by the chemical plant may be a physical product, such as a chemical, a biological, a pharmaceutical, a food, nutritional, a beverage, a textile, a metal, a plastic, a semiconductor, and/or a cosmetic. Additionally, or alternatively, the product may be a service product, for example, recovery or waste treatment such as recycling, chemical treatment such as breakdown or dissolution into one or more further chemical products. Some non-limiting examples of the chemical product may be organic or inorganic compositions, monomers, polymers, foams, pesticides, herbicides, fertilizers, feed, nutrition products, precursors, pharmaceuticals or treatment products, or any one or more of their components or active ingredients. In some cases, the chemical product may be a product usable by an end-user or consumer, for example, a cosmetic or pharmaceutical composition. The chemical product may be a product that is usable for making further one or more products, for example, the chemical product may be a synthetic foam usable for manufacturing soles for shoes, or a coating usable for automobile exterior. The chemical product may be in any form, for example, in the form of solid, semi-solid, paste, liquid, emulsion, solution, pellets, granules, powder.

A task instruction may relate to an objective of a task to be executed with respect to operating the chemical plant, apparatus, or process. It may relate to a generation task instructing a generative data-driven model to generate an output data set related to the operation of a plant. The task instruction may e.g. be a prompt for the generative data-driven model. The task instruction may comprise a sequence of one or more text elements. A task instruction may comprise, e.g. in form of a respective text element, at least one of the following (including combinations of): role information, context information, information on the format of the output data set to be generated, example information (for e.g. one-shot prompting), an instruction related to the output data set to be generated (e.g. a validation instruction for the query and/or the output data set instructing the generative data-driven model to validate the query and/or the generated output data set). The task instruction may comprise at least part of the query or generated query e.g. generated by another generative data-driven model from the query, the generated query comprising a similar request to the query. A task instruction may be embedded by the generative data-driven model into its latent space, e.g. by tokenization and encoding, wherein the task instruction is divided into smaller units or tokens, e.g. words or subwords. Each token may be assigned a unique identifier and may represent a discrete unit of meaning. Tokenization may help organize the task instruction into manageable parts for further processing by the generative data-driven model. The task instruction or tokens of the task instruction may then be encoded into a numerical representation or numerical representations compatible with the latent space of the generative data-driven model. Encoding of tokens may map the tokens e.g. of the task instruction to vectors or numerical values that may capture the semantic and contextual information of the task instruction.

A task instruction, in particular for generating the at least one output data set related to operating the at least one chemical apparatus, may be generated based on the query and a task instruction template. For instance, generating the task instruction may comprise: obtaining one or more task instruction template(s) related to operating the at least one chemical apparatus; selecting at least one task instruction template(s) of the one or more task instruction template(s) based on the query and/or the operation data set; generating the task instruction based on the at least one task instruction template(s) and the query (e.g. by filing parts of the template instruction with the corresponding information from the query and/or operation data set, which may be done rule-based or via prompting a/the generative data-driven model accordingly); and generating output data, such as the output data set, by providing the task instruction to a/the generative data-driven model. This may allow to generate a task instruction specifically tailored to a request made by an operator and may enhance the output the generative data-driven model provides. Selecting at least one task instruction template(s) of the one or more task instruction template(s) may be based on a similarity measure (e.g. Cosine similarity or Euclidian distance) in a common embedding space of the query and the one or more task instruction template(s). For instance, the query may be embedded. For instance selection may be based on a distance between embeddings (numerical representation) of the query and embedding (numerical representation(s)) of respective task instruction template(s). For example a similarity measure may be calculated between the embedded query and embeddings of the one or more task instruction template(s). For instance, the task instruction template relating to the embedded task instruction template closest to embedded query in relation to the similarity measure may be selected. In an example, to avoid mismatches, task instruction template relating to the embedded task instruction template closest to embedded query in relation to the similarity measure may be selected in case the similarity measure is below or above a predefined threshold value.

Retrieval data enabling retrieval of the at least one operation data set may e.g. be or comprise a hyperlink to a file containing the operation data set or a file from which the operation data set was created, so that an operator using the hyperlink may access the operation data set or the file in a time-efficient manner to validate the output data set provided by the generative data-driven model. For instance, retrieval data may e.g. be or comprise a hyperlink to a file containing the operation data set or a file from which the operation data set was created, so that an operator using the hyperlink may access the operation data set or the file in a time-efficient manner to validate the operation sequence data set provided by the generative data-driven model.

Further possible implementations or alternative solutions of the invention also encompass combinations—that are not explicitly mentioned herein—of features described above or below in regard to the embodiments. The person skilled in the art may also add individual or isolated aspects and features to the most basic form of this disclosure.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION THE DRAWINGS

In the following, the present disclosure is further described with reference to the enclosed figures. The same reference numbers in the drawings and this disclosure are intended to refer to the same or like elements, components, and/or parts.

FIG. 1 shows a schematic diagram of an operation of a plant, where an example of a method according to the first method is utilized.

FIG. 2A shows an example of a process for onboarding different operation data sets.

FIG. 2B shows an example of an embedding space comprising operation data embeddings.

FIG. 3 shows an example of the method according to the first aspect.

FIG. 4 shows an example of a training and fine-tuning process to obtain a fine-tuned generative data-driven model.

FIG. 5 illustrates an embodiment of input embedding.

FIG. 6 illustrates an embodiment of a transformer encoder architecture.

FIG. 7 illustrates an embodiment of a transformer decoder architecture.

FIG. 8 illustrates an embodiment of a transformer encoder-decoder architecture.

FIG. 9 illustrates an embodiment of training and/or deploying the transformer encoder.

FIG. 10 illustrates an embodiment of input embedding.

FIG. 11 illustrates an example of a multimodal generative data-driven model.

FIG. 12 illustrates an example of a multimodal decoder block of a multimodal generative data-driven model.

FIG. 13 illustrates an embodiment of a Mamba architecture.

FIG. 14 shows a schematic block diagram of an example apparatus e.g. according to the second example aspect.

### DETAILED DESCRIPTION

The following embodiments are mere examples for implementing the method, the system, the apparatus or application device disclosed herein and shall not be considered limiting. The following description serves to deepen the understanding and shall be understood to complement and be read together with the description as provided in the above summary and embodiment sections of this specification. Some aspects may have a different terminology than e.g. provided in the description above. The skilled person will nevertheless understand that those terms refer to the same subject-matter, e.g. by being more specific.

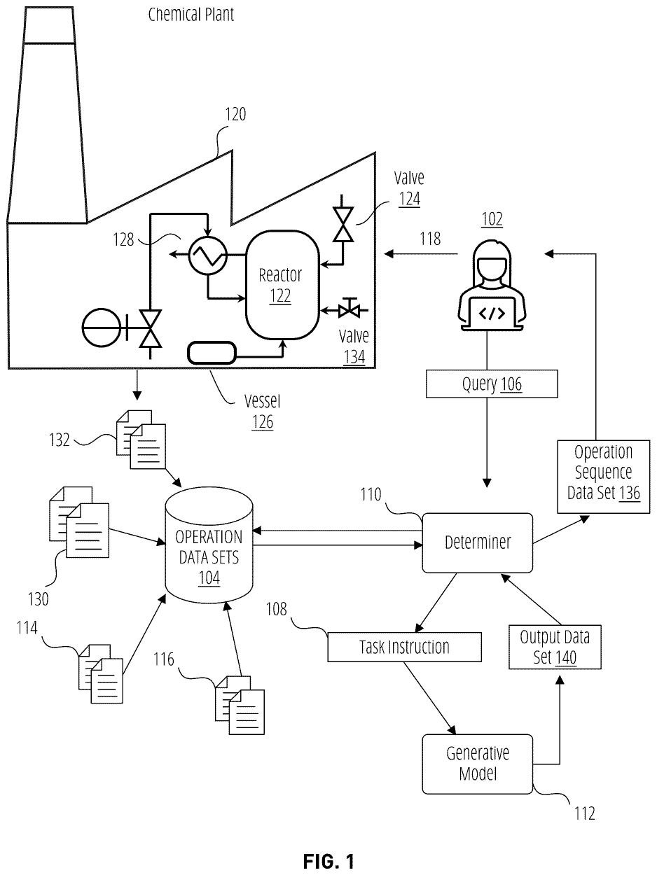

FIG. 1 shows an operator 102 operating a chemical plant 120. The chemical plant 120 comprises a complex chemical production line comprising inter alia a reactor 122 connected to valve 124, manual valve 134, heat exchanger 128 and vessel 126. A correct and long sequence of steps may be required to safely operate such a production line, in which it may be essential to e.g. close valve 124 before lowering the temperature in reactor 122, to avoid potential harm to operator 102 or damage to the production line or the environment. During plant operation a new or uncommon situation may arise which the operator 102 is not familiar with or unsure how to proceed safely. To assess the situation operator 102 formulates a short query 106 in natural language, such as “How to shut down R100?”, and submits it to system 138. System 138 determines, using a pre-prepared asset table, that the term “R100” refers to a specific chemical apparatus, in this case a specific reactor 122 of a specific chemical production line. Consequently, the term is replaced or expanded in the query with the available information (or data) from the asset table on reactor 122, such as its full name, location in the production line, any alternative designations and so forth. Such an expanded query may e.g. “How to shut down reactor 122 (R100)?”. The expanded query is passed on to determiner 110.

Determiner 110 is configured to obtain a pre-determined number of operation data sets related to the query 106 from a data base of operation data sets 104 comprising data related to the operation of the chemical plant 120. Alternatively, determiner 110 is configured to obtain the operation data sets related to the query 106—from a data base of operation data sets 104—that are most similar to the query. For instance, a similarity measure (e.g. via using associated operation data embeddings in an embedding space) is determined between the operation data sets and the query and the operation data sets associated with their similarity measure being below a threshold are obtained (e.g. instead of a pre-determined number of most similar operation data sets).

For instance, the operation data sets 104 may e.g. comprise at least a part of manuals 116, historical logs 132 provided e.g. by other plant operators 102 on past operation of the chemical plant 120, specifications 130, and/or operation procedures 114. Determiner 110 may optionally determine whether the query and the operation data sets 104 are not associated with a same context data set and exclude operation data sets 104 from further search, e.g. no similarity measure may need to be determined for the excluded operation data sets. Determiner 110 may determine whether the query comprises at least one element related to the operation of the plant and determine a keyword score for each of the operation data sets 104, e.g. using a BM25 model. For instance, determiner 110 may carry-out a keyword search, e.g. for any of the alternative terms for reactor 122 from the asset table, to narrow down the number of potentially relevant operation data sets 104 to operation data sets related to the operation of the specific chemical apparatus e.g. reactor 122, which may save computing time and memory storage. The keyword search may e.g. be conducted on meta-data associated with the operation data sets 104. The operation data sets 104 or the narrowed down number of operation data sets 104 are embedded in a common embedding space, the embedding space comprising the embeddings (e.g, wherein an embedding is a vector representations) of the operation data sets 104 (i.e. the operation data embeddings). Embedding the operation data sets 104 may be performed prior to deploying system 138 for operators 102. Determiner 110 may obtain pre-obtained embeddings of the operation data sets 104 or of the narrowed down number of operation data sets 104. Determiner 110 embeds the expanded query into the (e.g. common) embedding space of the operation data sets 104 and identifies a pre-determined number of operation data embeddings of the (e.g. plurality of) operation data embeddings (i.e. embeddings of the operation data sets 104), the identified operation data embeddings being closest (i.e. most similar) to the embedded query in the embedding space with respect to a similarity measure, such as cosine similarity. Determiner 110 may then obtain the pre-determined number (e.g. five) of operation data sets as the pre-determined number of operation data sets corresponding to the identified pre-determined number of operation data embeddings.

Determiner 110 may determine a task instruction 108. Task instruction 108 may comprise an indication of the obtained operation data sets and/or at least a part of the obtained operation data sets. Preferably the task instruction 108 comprises the obtained operation data sets, e.g. as context information for the generative model 112. This may be done in a structured manner, e.g. providing an identifier of the operation data set in front of a respective operation data set, so that the generative model 112 may generate operation sequence data set 136 while citing the respective operation data set on which respective parts of the operation sequence data set are based in an efficient manner, e.g. without including the whole operation data sets, which may allow for saving computational costs such as energy due to a smaller amount of tokens being generated. Task instruction 108 may comprise an instruction to validate the query and/or the at least one operation sequence data set to increase reliability of the generated operation sequence data set 136. Task instruction 108 may further comprise a persona to guide the generation of the operation sequence data set 136, e.g. in a syntactic and semantic manner, and provide additional context for the generative model 112.

Task instruction 108 may comprise an instruction to provide and/or summarize and/or highlight information on safety risks and/or pitfalls mentioned in the obtained operation data sets, so that operator 102 becomes aware of and can timely assess and avoid any risks associated with the planed operation of the chemical plant 120. Further, task instruction 108 comprises the expanded query. Task instruction 108 is then provided to generative model 112 to determine the at least one operation sequence data set. The generative data-driven model has been previously trained to generate the at least one output data set related to the operation of a chemical plant in response to obtaining a task instruction. The determined at least one operation sequence data set 136 comprises the generated at least one output data set and identification data for identifying the obtained operation data sets, e.g. hyperlinks to the obtained operation data sets and/or at least part of the obtained operation data sets may be included. The output data set may comprise respective citations of the obtained operation data sets, which may enable an operator to time-efficiently validate parts of the output data set by referring to an original (e.g. human prepared) documentation data set that comprises the respective obtained operation data set. System 138 provides the generated at least one operation sequence data set 136 to operator 102, e.g. by displaying it on a display, together with at least a part of the obtained operation data sets and hyperlinks to files containing the obtained operation data sets so that operator 102 may timely assess and validate the at least one operation sequence data set 136 and decide, based on the at least one operation sequence data set 136, how to operate the chemical plant 120, e.g. how to safely shut down reactor 122.

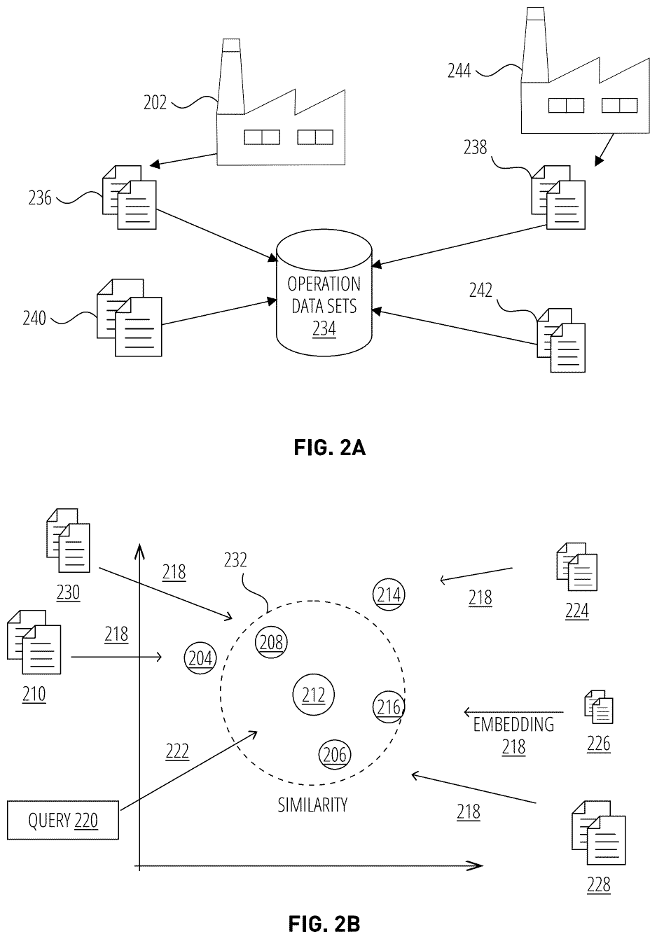

FIG. 2A shows an example of a process for onboarding different operation data sets 236, 238, 240, 242 into a set of a plurality of operation data sets 234, an operation data set 236 may be or comprise at least a part of operator logs which may be provided by plant 202, e.g. automatically received or provided by an operator of plant 202. Operation data set 238 may be or comprise at least a part of log 238, which may be provided by another plant 244. Logs may be based on and comprise sensor measurements, such as temperature or material flow, on chemical processes or chemical apparatuses used during production of a chemical product.

As an example, a data set related to the operation of plant 202 (and/or plant 244) to be included in the operation data sets 234 for later retrieval, may be copied to a data base.

In case a data set comprises text, e.g. in natural language, the text may be extracted and divided into parts (e.g. chunks) of the (e.g. larger) data set that may be used as context information to be included in a task instruction. An operation data set may be or comprise such a part. The size of a part may be determined by the format of the text, e.g. where a procedure is comprised, a part may encompass essentially the whole procedure, so that the time-sequence of the steps provided in said procedure remains intact.

An operation data set may be or comprise (e.g. essentially) a whole procedure or other (time-) sequential data. Whether a data set comprises a procedure or other sequential data may be determined by semantic or syntactic information such as a heading, a document name, or title or metadata associated with the text. Whether a data set comprises a procedure or other sequential data may also be determined using a classifier model, e.g. a transformer model like Llama, Mistral, GPT or BERT, or a Bayes classifier. Upon determining that a data set comprises a procedure or other sequential data, the data set may be divided into parts keeping the (identified) procedure or other sequential data (e.g. essentially) intact.

The size of a part may have a pre-defined limit (e.g. 250 words), e.g. to limit the number of tokens used in a task instruction. In this case, each operation data set from a larger data set (e.g. related to a same procedure) may comprise also a part of another operation data set, e.g. an adjacent part, or adjacent (w.r.t. the larger data set) operation data sets may overlap, e.g. by up to 10 percent. An operation data set comprising a part as described above may also be associated with meta data such as a reference to the larger data set from which the part originates, a position within said larger data set, and/or a (e.g. short, e.g. 10 words) summary of the larger data set. A (e.g. short, e.g. 10 words) summary of the larger data set may be comprised by the operation data set, the summary may e.g. be included in front of the part or after the part and may allow that during retrieval of operation data sets, operation data sets of the same origin are located close together in the embedding space. A summary may e.g. indicate a procedure being contained in the larger data set. A reference to the larger data set and/or a number of the part may be included in the operation data set in a similar manner. This may allow to obtain the position of the part relative to other parts and to combine these parts (while e.g. removing any overlapping or duplicate text), so that in particular time-sensitive procedures may be provided essentially as a whole as context in a task instruction.

In case a data set comprises text, e.g. in natural language, and the text comprises a number of terms, before creating an operation data set, it may be determined whether the text comprises a reference to a term comprised in a pre-prepared mapping of the term to further information data on the chemical apparatus, For instance, it may be determined, for example using a keyword search, whether the text comprises a term or a variation of a term listed in an asset table. Upon determining that the text comprises a reference to such a term, the term may be replaced or expanded based on the pre-prepared mapping, e.g. in case the data set comprises the term “R100”, an asset table may map R100 to a specific reactor 122 in plant 202, it may be expanded to “Reactor 122, R100”, which may allow for enhanced performance when retrieving data sets. Additionally or alternatively, such an expanded term may be included in metadata associated with the operation data set and/or the operation data embedding e.g. to avoid altering the original text. Such metadata may e.g. be used in a keyword search based on a query to narrow the number of operation data sets from which to obtain the operation data sets that may be used to determine a task instruction, by e.g. first filtering the operation data sets or operation data embeddings using a keyword search (e.g. for the term “R100”) and then performing a similarity search (e.g. by determining similarity measure) only on the embeddings of the filtered operation data sets (e.g. filtered operation data embedding).

The obtained operation data sets may be or may have been embedded into an embedding space using an embedding model. Preferably, the embedding model may be an encoder only transformer model (e.g. transformer encoder architecture), which may comprise a self-attention layer, which may allow for an enhanced representation of context and structure of on operation data set in an operation data embedding. For instance, BERT (Bidirectional Encoder Representations from Transformers), RoBERTa (Robustly Optimized BERT), or ELECTRA (Efficiently Learning an Encoder that Classifies Token Replacements Accurately) may be used to determine an operation data embedding for the obtained operation data sets (and for embedding the e.g. pre-processed query). An operation data embedding may be stored in a database, e.g. in a data structure comprising the operation data embedding and at least one of: identification data for identifying the corresponding operation data set (such as at least a part of the operation data set, a title associated with the operation data set, or a hyperlink to the operation data set), the corresponding operation data set, retrieval data enabling retrieval of the operation data set (such as a hyperlink to the associated operation data set or a data set comprising the operation data set like a document), a time stamp, and a classification (e.g. “procedure”, “log”, “data sheet”, “manual”, which may be obtained using classifier model).

From the plurality of operation data sets 234 (e.g. previously onboarded) at least one operation data set comprising data related to the operation of the plant may be obtained for further processing of the method according to the first aspect. The onboarding is preferably performed offline, e.g. before deploying the system carrying-out the method according to the first aspect for use by operators. However, at any time new data sets may be onboarded in above described manner, even after deploying the system.

FIG. 2B shows an example of an embedding space, wherein operation data sets 230, 210, 218, 226, and 228 are embedded in the embedding space. For instance, operation data set 210 is embedded 218 using a trained embedding model resulting in the corresponding operation data embedding 204. Likewise operation data sets 230, 224, 226, and 228 have corresponding operation data embeddings 208, 214, 216, and 206. The operation data embeddings may have been obtained prior to the system being queried by an operator, and the operation data embeddings may be already stored in a data base. A mapping may be obtained that maps the operation data set to the corresponding operation data embedding, such as a table or an entry in meta data associated with the operation data embedding. An operator of the plant sends a query 220. To retrieve the most relevant operation data sets, the query 220 or a pre-processed query 220 may be embedded 222 in the embedding space, e.g. using the same trained embedding model used during the onboarding of the operation data sets. A similarity measure is determined, for instance a dot-product similarity or a cosine-similarity, and the operation data embeddings 208, 216, 206, which may be located within a threshold similarity 232 around the embedded query 212 in the embedding space or which may correspond to a specified number (e.g. three) of closest operation data embeddings to the embedded query 212 in the embedding space, are found. Then, the corresponding operation data sets 230, 226, and 228 may be obtained using a mapping between the operation data embeddings and the operation data sets.

A cosine similarity may be a measure of the cosine of the angle between two embeddings (which may be vectors in the embedding space). For a query embedding vector Q and an operation data set embedding (i.e. An operation data embedding) R it may be:

$$cos ( θ ) = \frac{Q \cdot R}{( ‖ Q ‖ \cdot ‖ R ‖ )}$$

wherein Q·R is the dot-product of Q and R, and ∥Q∥ and ∥R∥ are the magnitude or norms of Q and R. The dot-product by itself may also be used as a similarity measure. It corresponds to a scalar and may be obtained by multiplying corresponding entries of the two embeddings and then summing those products to determine a scalar as the dot-product.

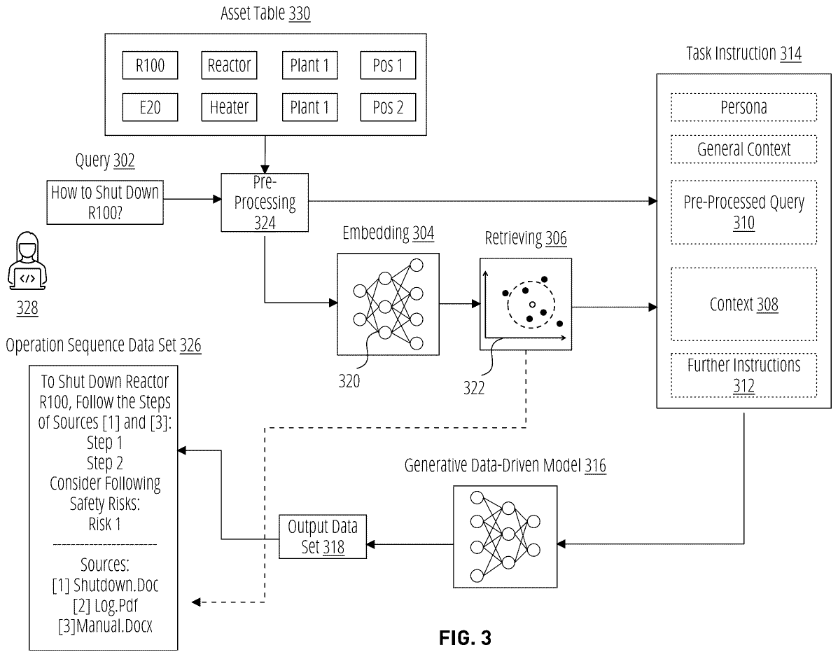

FIG. 3 shows an example of the method according to the first aspect. An operator 328 sends a query 302 to the system. The query 302 is pre-processed 324. Pre-processing may comprise identifying a term associated with a chemical apparatus or equipment used in a production line of a plant. For instance, a term may be searched, e.g. using a keyword search, in a data structure that allows associating terms with terms of similar meaning or further information related to the term, e.g. a table in which all entries in a row relate to the same chemical apparatus. For this, an asset table 330 may be used, in which e.g. term “R100” is associated with a “Reactor” of “Plant 1” at position “Pos 1”, likewise if the query comprises a term such as “Heater of plant 1”, the asset table 330 may allow associating this with “E20”. In case the term is found in the asset table 330, it may be replaced or expanded in the query using the associated further information on the chemical apparatus or equipment. Pre-processing 324 may further comprise identifying terms provided in the asset table 330 by permutating terms comprised by the query, e.g. “R-100”, “R100”, and “R 100” may relate to the same chemical apparatus or equipment.

For instance, a regular expression may be used to find all possible matches of a name of a chemical apparatus or equipment in a query or in an operation data set (e.g. for filtering, for use in a keyword search, determining a keyword score and the like). For example, an iteration over an (equipment) mapping e.g. an asset table may be used to find names of chemical apparatus or equipment, wherein a function may be used to create variations (e.g. synonyms) that may appear in e.g. the query or operation data set, e.g. replace characters and remove trailing letters to create variations of the apparatus or equipment name. Likewise a mapping (e.g. chemical mapping) may be used to identify and expand or replace names, smiles or the like of chemicals in a query or append these in context data sets to an operation data set. A function to create variations may e.g. comprise to insert whitespace characters or vary found whitespace characters, it may include, replace or vary hyphens, dashes, minus-signs, slashes etc. and/or it may vary usage of capital letters.

It may be checked if any of the variations (e.g. synonyms) are an exact match with any of the elements in the mapping e.g. an equipment mapping or an asset table. If a match is found, the name of the chemical apparatus or equipment name may be added as meta-data e.g. in form of a context data set to the query or operation data set. For each identified name of a chemical apparatus or equipment, the dependent context of that chemical apparatus or equipment may be added as a context data set, e.g. “R-100 belongs to a concentration section of the plant”. Such dependent context may e.g. be based on or retrieved from a process and instrumentation diagram (e.g. P&ID or PID). For instance, during obtaining (e.g. onboarding) operation data sets for a database of operation data sets, each operation data set may be associated with such context data sets, which e.g. may enhance retrieval by comparing the context data sets associated with the operation data sets with context data sets associated with the query. In an example each operation data set (e.g. during onboarding into a database of operation data sets) may be associated with an embedding of the operation data set (e.g. by associating an identifier with the operation data set, that references embedding of the operation data set. Also, each operation data set (e.g. during onboarding into a database of operation data sets) may be associated with at least one context data set, e.g. comprised by meta-data associated with the operation data set.

The pre-processed query 310 may be included in the task instruction and used to obtain at least one operation data set comprising data related to the operation of the plant. To this end, a plurality of operation data sets, e.g. from a data base of operation data sets, may be filtered using a keyword search based e.g. on the term replaced or expanded previously to obtain a filtered (e.g. narrowed down) plurality of operation data sets. A plurality of operation data embedding corresponding to the filtered operation data sets may be obtained, e.g. from a previously prepared data base.

The pre-processed query 310 may be embedded 304 using an embedding model 320, e.g. a trained data-driven model, e.g. a transformer model trained to determine an embedding into embedding space 322 for a given operation data set. In the embedding space a similarity measure such as cosine similarity may be used to identify at least one operation data embedding of the plurality of operation data embeddings closest to the embedded query in the embedding space. The identified at least one operation data embedding may be retrieved 306 and the associated operation data set included as context 308 in task instruction 314 (i.e. including at least a part of the at least one operation data set in task instruction 314).

Alternatively, accuracy of the obtained operation data sets in relation to the query may be enhanced by using a retrieval score increase to determine which operation data sets to obtain or retrieve. A retrieval score may comprise weighing the similarity measure obtained in the embedding space with further scores such as a keyword score (e.g. based on the number of keyword matches between a query and on operation data set in relation to the number of keyword matches between the query and other operation data sets) or context score (e.g. based on the number of context data sets shared between the query and the operation data set. For example, a context score may be used as a weight for the similarity score (e.g. based on the similarly measure in an embedding space). This may for example comprise: Determining a similarity score between the query and at least one operation data set based on a similarity measure between an embedding of the query and respective operation data embedding (i.e. an embedding of the at least one operation data set) in an embedding space; Determining the retrieval score based on the similarity score; Determining whether the query and the at least one operation data set are associated with at least one same context data set; Upon determining that the query and the at least one operation data set are associated with at least one same context data set, determining a score increase based on the number of same context output data sets, wherein the retrieval score is based on the similarity score increased by the score increase. For instance it may comprise:

Calculate similarity score dᵢ between query q and all operation data sets (e.g. chunks) cᵢ dᵢ=cos (q, cᵢ); Weigh similarity score based on asset (or chemical) context match Dᵢ=dᵢ+w·match_context(q, cᵢ), wherein w may be between 0.1 and 0.3, e.g. 0.2 and match_context(q, cᵢ) may be 1 if an operation data set and the query have at least one same context data set or are associated with a same chemical apparatus or chemical. Alternatively, match_context(q, cᵢ) may be equal to the number same context data sets associated with the operation data set and the query, e.g. the number of references to the same chemical apparatus or chemical in both the query and the respective operation data set. A hybrid search may be used for obtaining operation data sets related to the query. For instance:

determining a number (e.g. 50-200, e.g. 100) of operation data sets based on a (e.g. weighted) similarity score, determining a number (e.g. 50-200, e.g. 100) of operation data sets using a BM25 keyword search (as an example of a keyword score), combining the both sets of operation data sets in a weighted manner, e.g. 50:50. For instance using Reciprocal Rank Fusion (RRF) with

$$RRFscore ( o ∈ P ) = \sum [ \frac{1}{k + r ( o )} ]$$

wherein k may be a constant that helps to balance between high and low ranking and r(o) may be the rank/position of the operation data set (o) of a plurality (P) of operation data sets. The rank/position of an operation data set with respect to a given score (e.g. similarity score, keyword score) may be based on the order the operation data sets in relation to the score. For instance, an operation data set being the most similar with respect to the similarity measure (e.g. having the highest similarity score of a plurality of operation data sets) would have rank 1 with respect to the similarity measure. The same operation data set may however have the third best keyword score of the plurality of operation data sets and would have rank 3 with respect to the keyword score. The RRFscore of that operation data set may hence be sum of 1/1+1/3. The RRFscore may then be used as the retrieval score for obtaining the operation data sets, e.g. obtaining the operation data sets having a RRFscore above a threshold value.

Reciprocal Rank Fusion may be a method used for merging the operation data sets obtained based on the similarity score, the context score, weighted similarity score and/or keyword score. It may enhance the performance of the information retrieval process by combining the strengths of the different systems. RRF may be based on the Reciprocal Rank (RR) of an individual operation data set, which is the multiplicative inverse of its rank. For instance, if a document is at the first rank, its RR is 1, if it is second rank, RR is 1/2, if it is third rank, RR is 1/3, and so on. For RRF the RR values based on different scores may be combined. The RRF of an operation data set may be the sum of the reciprocal rank scores resulting from the different scores (e.g. keyword score, similarity score). So RRF may assign higher scores to operation data sets that are ranked highly in relation to different scores. This may allow to be less sensitive to the rank positions according to individual scores. RRF may require less computational resources compared to other fusion methods.

Further, task instruction 314 may comprise a persona, general context, such as that the output data set should relate to the chemical industry, and/or further instructions 312. Further instructions 312 may comprise an example or template for e.g. formatting the output data set 140, e.g. one or more examples (e.g. one- or few-shot) may be provided on how to refer to or cite a specific operation data set, which may e.g. allow to use less tokens in generating the output data set 140. The instruction may be to use specific identifiers representing respective operation data sets.

Further instructions 312 may comprise an instruction to include a citation of the at least one operation data set in the at least one output data set, so that the output data set 318 may comprise citations e.g. for different parts, which may enhance an operators 328 ability to timely validate the operation sequence data set 326. For instance, a sequence of steps comprising steps from different documents may be validated by referring to the respectively cited operation data set for each step. The validated operation sequence data set 326 may then be used for operating the plant. Further instructions 312 may comprise an instruction to validate the query, so that the generative data-driven model 316 may generate an output data set 318 comprising a warning, if the query 302 did not correspond to a recognized operation of a plant. Further instructions 312 may comprise an instruction to validate the at least one output data set 318, so that the output data set 318 may comprise reasoning steps and which may allow the generative data-driven model 316 to generate output data set 318 from complex task instructions. An instruction to validate may e.g. correspond to chain-of-though prompting, e.g. the instruction may instruct the generative data-driven model 316 to generate the output data set step-by-step. Further instructions 312 may comprise an instruction not to include the obtained at least one operation data set in the output data set 318 and e.g. rather include a reference to the at least one operation data set. Further instructions 312 may comprise an instruction to include further relevant information data, e.g. actions, risks, and/or pitfalls, associated with the queried operation of the plant, so that the output data set 318 may comprise e.g. safety risks associated with the queried operation that are mentioned in an operation data set.

The determined task instructions 314 is provided to generative data-driven model 316, which generates an output data set 318 as e.g. described in relation to FIG. 1.

Then, an operation sequence data set 326 is provided e.g. to operator 328, wherein the operation sequence data set 326 comprises the output data set 318 and identification data for identifying the obtained (306) operation data sets. As identification data for identifying the operation data sets the operation sequence data set 326 may comprise at least a part of the identified operation data sets, e.g. associated with an identifier that the generative data-driven model 316 was instructed—in task instruction 314—to use for referencing the operation data sets. Identification data for identifying an operation data set may be at least a part of the operation data set, a title associated with the operation data set or a (e.g. larger) data set of which the operation data set is a part of, or a hyperlink to the operation data set or a (e.g. larger) data set of which the operation data set is a part of. The identification data for identifying an operation data set may be based on the obtained/retrieved operation data embedding. The identification data may e.g. be obtained from meta data associated with an obtained operation data embedding, indicating the corresponding operation data set. The identification data for identifying an operation data set is not generated by the generative data-driven model 316. This may enhance an operators' ability to validate the operation sequence data set 326 in a more time-effective manner, as both the generated output data set 318 and the operation data sets used as sources for the generated output data set 318 are directly available. The operation sequence data set 326 may comprise retrieval data enabling retrieval of the (obtained) operation data sets, e.g. comprise a hyperlink to a file containing the operation data set or a file from which the operation data set was created, so that an operator using the hyperlink may access the operation data set or the file in a time-efficient manner to validate the output data set provided by the generative data-driven model 316.

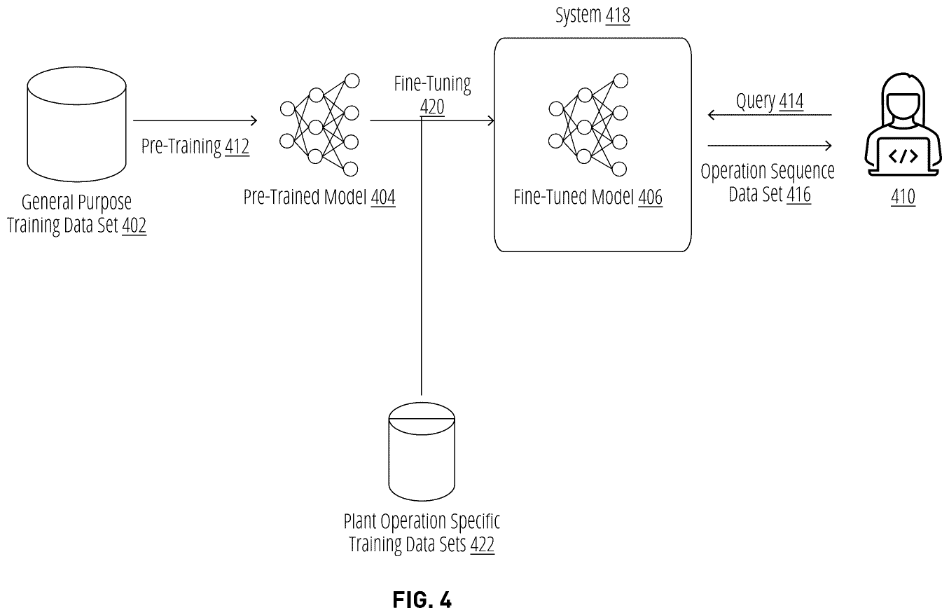

FIG. 4 shows an example of a training and fine-tuning process to obtain a fine-tuned generative data-driven model 406. A general-purpose generative data-driven model 404 may have been (pre-) trained using a large number of training data sets, which may be unlabeled data sets, in an unsupervised manner. Training may involve tokenizing input texts and masking a number of tokens of the input text. The weights of the generative data-driven model may then be adjusted based on the accuracy of generating the masked tokens, wherein the accuracy may be measured by a metric such as in cross-entropy loss or maximum likelihood estimation. The pre-trained model 404 may then be fine-tuned 420 using for example a number of labeled plant operation specific training data sets 422, comprising queries and respective (correct) output data sets. Preferably, low-rank adaptation or parameter-efficient fine-tuning (PEFT) is used for fine-tuning 420, which may allow for efficient fine-tuning and may reduce the risk of the pre-trained general purpose generative data-driven model 404 losing the pre-trained weights (i.e. catastrophic forgetting). The fine-tuning 420 may involve creating a number of training queries, e.g. by consulting operators on likely queries or using a generative data-driven model to generate queries, wherein an operator is included as a production persona in the prompt for generating the training queries, which may enhance the quality of the output. Operation sequence data sets may then be generated based on the trained queries using the pre-trained general purpose generative data-driven model 404. The operation sequence data sets may then be corrected e.g. by consulting respective experts for the operation of the plant and the corrected operation sequence data sets may be used as labels for the respective training queries. The labeled training queries, i.e. pairs of training query and corresponding corrected operation sequence data set may then be used for fine-tuning 420 as plant operation specific training data sets 422.

For instance, at least one plant operation specific output layer may be added to the pre-trained model 404 which may be trained using the plant operation specific training data sets 422, wherein the weights of the generative data-driven model may be kept static during fine-tuning.

The fine-tuned model 406 may be used as the generative data-driven model for generating an operation sequence 416 for a query 414 of an operator 410, which may enhance the quality of the generated output data sets.

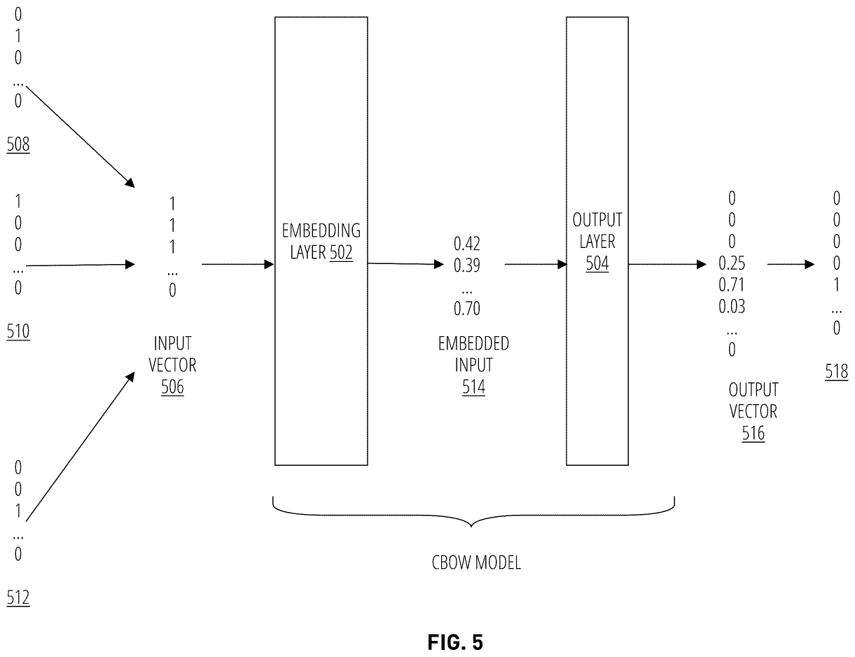

FIG. 5 illustrates an example embodiment of input embedding in particular for generative data-driven models or machine-learning architectures using an embedding layer 502 such as a transformer encoder, transformer decoder or transformer encoder decoder architecture.

An input embedding may be obtained by training for example a continuous bag of words model (CBOW) or a skip-gram model. The embedding layer may be suitable for generating embedded input data based on input data. Generating embedded input data may refer to embedding input data. Embedding input data may result in a representation associated with the input data. Thus, the embedded input 514 may be the representation associated with the input data. The input data may comprise one or more elements. The one or more elements may be represented by the input vector 506. In particular, the embedded input 514 and/or the input vector 506 may be machine-readable and/or processable by a processor. For this purpose, the embedded input 514 and/or the input vector 506 may be a tensor, in particular a first-rank tensor. Specifically, the input vector 506 may be a one-hot vector or a summation of a plurality of one-hot vectors. A one-hot vector may be a vector with one entry unequal to zero. Examples for one-hot vectors may be 508, 510 and 512. The entries unequal to zero in the one-hot vector and/or in the input vector 506 may indicate the element. For example, a lookup table may define the relation between the position of the entries unequal to zero and the element indicated by the one-hot vector. The lookup table may specify a plurality of different elements. The number of different elements may be equal to the number of entries in the one-hot vector. The number of different elements may be referred to as vocabulary size. In an example, the elements may be represented by tokens and a sequence of elements may refer to at least a part of a sentence. The at least a part of the sentence may be represented by a plurality of tokens. A token may represent at least a part of the element and/or word. For example, where one element would be associated with only one word, words such as “embeddings”, “embedding” or “embed” would constitute different elements. A first token may represent the stem “embed” and the endings, typically appearing in a plurality of word, may be represented by a second token, a third token and a fourth token. The second token, the third token and the fourth token may be used for representing other words such as “look”, “looking” or the like, preferably together with a fifth token representing the stem “look”. Ultimately, this tokenization of elements associated with a plurality of stems and a plurality of endings results in less tokens to be used for representing a plurality of elements and thus, uses less computational resources.

A lookup table specifying a subset of the vocabulary size e.g. of the English language may comprise 10,000 words or more. The embedded input 514 may be a lower-dimensional representation than the input vector 506. For example, typical embedded inputs 514 may comprise some hundreds of different entries. Followingly, the embedded inputs 514 constitute a densified representation of one or more elements using less computational resources. More than that, the embedded input 514 may represent a relation between two or more elements. For example, the words “Italy” and “Germany” may be similar or may be more closely related since they both define European countries, whereas the the word “embodiment” may be very different from the two respective words. The smaller the dot product between two embedded inputs 514 may be the more similar the two elements associated with the embedded inputs 514 may be. Hence, the embedded inputs 514 may represent one or more elements accurately and lead to accurate results based on processing the embedded inputs 514.

For transforming the input vector 506 into the embedded input 514, the embedding layer may comprise a number of neurons equal to the number of entries in the embedded input 514. Based on the embedded inputs 514, the output layer may generate the output vector 516. The output vector may be a vector and/or may indicate one or more elements. The output vector 516 may indicate one or more elements different from the input vector 506 and/or the one-hot vectors associated with the input vector 506. For this purpose, the output layer may comprise a number of neurons equal to the number of entries of the input vector 506 and/or the output vector 516. The output layer may apply a softmax function to the embedded inputs 514. By doing so, the output vector may comprise the probabilities associated with the elements associated with the entries of the output vector 516 unequal to zero. Hence, from the output vector 516 one or more elements may be obtained with a corresponding probability. Where the input vector 506 may specify one or more sequence(s) of elements, the output vector 516 may specify one or more elements corresponding to the sequence(s) of elements specified by the input vector 506. In the example of FIG. 5, the element associated with vector 518 may correspond to the input vector with a probability of 71%. Additional or alternative elements may correspond to the input vector as indicated by the output vector with lower probability. By defining a threshold to which the probability may be compared, the selection of the corresponding elements may be tailored to the needs of the user. The elements generated by the model comprising the embedding layer 502 and the output layer 504 may refer to the most probable elements indicated by the output vector 516. Hence, the model depicted in FIG. 5 may generate the element associated with the vector 518 with a confidence score of 71%.

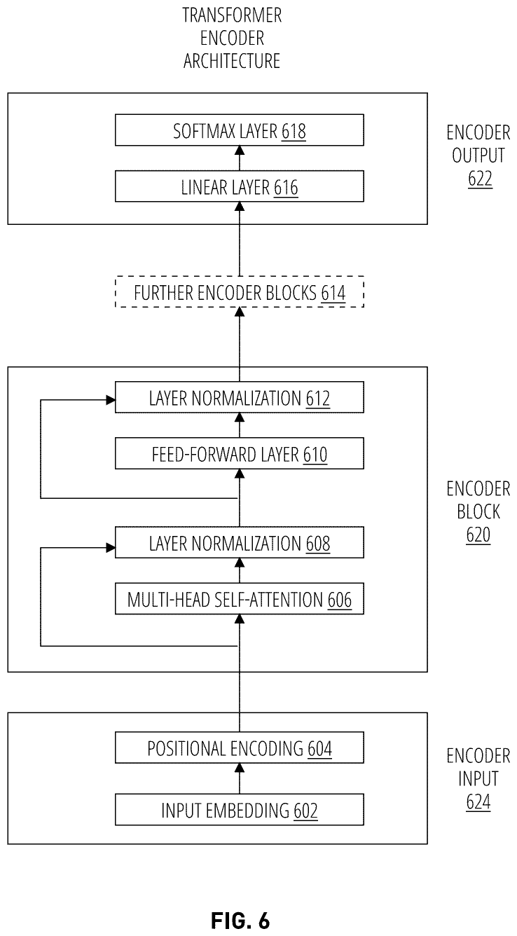

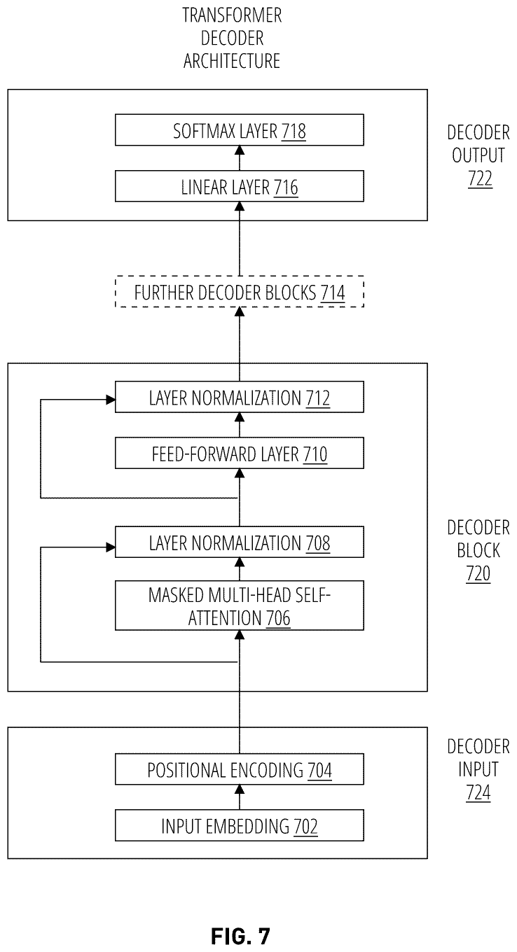

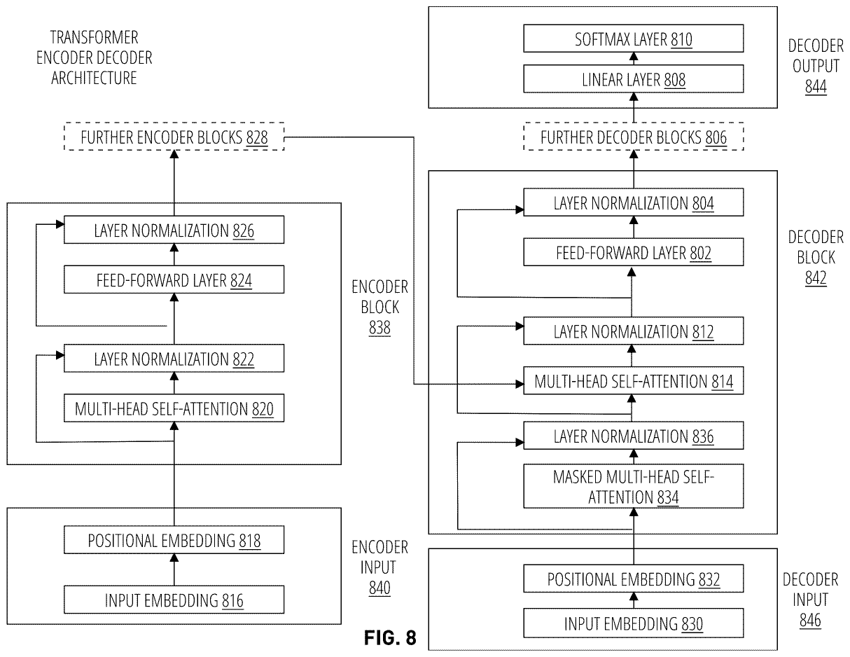

The model of FIG. 5 may be continuous bag of words (CBOW) model. The CBOW model may be trained based on a training data set comprising a plurality of input vectors and corresponding output vectors. As the training data set may not be labeled, the training of the CBOW model may be referred to as self-supervised. Before training of the CBOW model, the CBOW model may be initialized with random values assigned to the weights of the neurons. During the training of the CBOW model, the input vectors may be passed through the initialized embedding layer and the output layer and a loss may be determined by comparing the output vector obtained by passing the input vector 506 through the model to the output vector corresponding to the input vector 506 as specified by the training data set. Based on the determined loss, backpropagation may be applied to determine the gradients associated with the neurons of the embedding layer 502 and the output layer 504 to lower the loss. According to the determined gradients, the weights of the neurons may be updated by using a gradient descent algorithm. If a predetermined loss may be achieved by the CBOW model, the training may be terminated and a trained CBOW model may be obtained. From the trained CBOW model, the embedding layer 502 may be suitable for embedding input data comprising one or more elements. This embedding layer 502 may be used in other machine-learning architectures requiring an embedding layer 502 such as a transformer encoder, transformer decoder or transformer encoder decoder architecture as described within the context of FIG. 6, FIG. 7 and FIG. 8. For training these architectures, a trained embedding layer 502 may be required. Hence, a model such as a CBOW model may be trained prior to training the transformer encoder, transformer decoder or transformer encoder decoder architecture.

Further, applying input embedding may include determining a numerical representation of the input data by determining the number of elements and/or parts of the input data. Hence, the numerical representation of the two or more elements, in particular of a predefined size, may be indicative of a number of occurrences of the elements and/or parts of the input data. In an example, the numerical representation of the two or more elements indicative of a number of occurrences of the elements of the input data may be a vector with a plurality of entries where one entry may be indicative of the occurrence of one element of the input data.

FIG. 6 illustrates an embodiment of a transformer encoder architecture e.g. of an encoder-only transformer model, which may be utilized for obtaining an operation data embedding from an operation data set.

The transformer encoder comprises an encoder input 624, one or more encoder blocks 620, 614 and an encoder output 622. In particular, the transformer encoder may be referred to as X-former. The transformer encoder architecture may correspond to the encoder architecture associated with the transformer encoder-decoder architecture with an additional encoder output instead of connecting the encoder block directly to the decoder of the transformer encoder-decoder architecture. An example of a transformer encoder architecture is the bi-directional encoder representations from transformers (BERT).

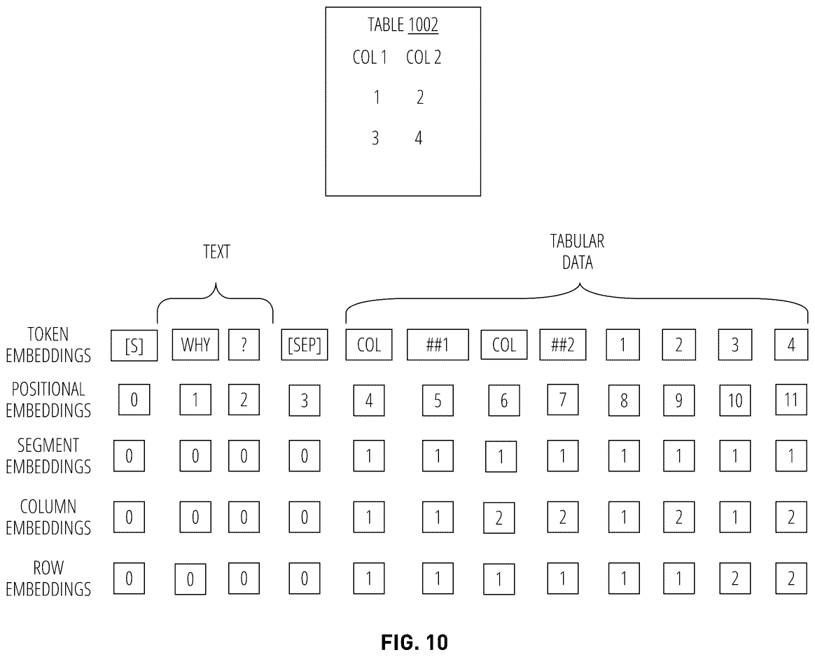

The input data may be received at the encoder input 624. The input data may comprise at least one of text data, numerical data, tabular data, image data or the like. Where the input data may comprise one of text data, numerical data, tabular data, image data or the like, input embedding of a type corresponding to the type of input data may be applied. The type of the input data may be text data, numerical data, tabular data, image data or the like. In an embodiment, the input data may be associated with two or more types of input data. The input embedding may be associated with the two or more types of input embedding, in particular according to the input data. Hence, the input embedding may be configured to map text data, numerical data, tabular data, image data or the like to a numerical representation of the input data. In particular, at least one first type of input embedding may be applied to at least a part of the input data associated with one first type of input data. Further, at least one second type of input embedding may be applied to at least a part of the input data associated with one second type of input data. The model associated with the input embedding comprising the at least one first and at least one second type of input data may be referred to as multimodal model. The generative data-driven model may be a multimodal generative data-driven model. The type of the input data may correspond to a modality. An example of input embedding associated with text data can be found in the context of FIG. 5. An example of input embedding associated with numerical and/or tabular data can be found in the context of FIG. 10.

An exemplary method includes: obtaining a query related to operating at least one chemical apparatus of the plant; obtaining, based on the query, at least one operation data set comprising data related to an at least two dimensional representation related to operating the at least one chemical apparatus, e.g. a P&ID; determining or obtaining identification data for identifying the at least one operation data set, based on the obtaining the at least one operation data set; determining at least one operational data set, the determining the at least one operational data set comprising: providing a task instruction, based on the query and the at least one operation data set, to at least one generative data-driven model, the at least one generative data-driven model having been trained on general purpose training data sets to generate at least one output data set related to operating the at least one chemical apparatus in response to obtaining the task instruction; and providing the at least one operational data set, wherein the at least one operational data set comprises the at least one output data set and the identification data for identifying the at least one operation data set.

Receiving and/or providing the input data may comprise identifying two or more elements of the input data. This may be referred to as tokenization. For this purpose, a vocabulary may be available. The vocabulary may specify a plurality of elements, in particular elements typically repeating in data of the type of the input data. For example, where the input data may be text data, the vocabulary may comprise several endings and/or word stems. In an embodiment, the elements of the input data may be specified by a selection indicative of the plurality of elements provided.

The encoder input 624 may apply an input embedding 602, in particular to the two or more elements of the input data. Applying the input embedding 602 may refer to passing the input data, in particular the two or more elements of the input data preferably separately, through one or more embedding layer e.g. as described within the context of FIG. 5. Applying the input embedding may comprise mapping the input data, in particular the two or more elements of the input data to a numerical representation of the input data. The numerical representation may be indicative and/or may be related to the input data. Mapping the input data to the numerical representation of the input data may comprise identifying two or more elements of the input data. For example, where the input data may be text data, the text may be divided into one or more token(s). The one or more element(s) may be mapped to a numerical representation of the one or more part(s). In particular, the number of element(s) may be equal to the number of numerical representation of the element(s). The numerical representation may be a tensor, in particular a vector and/or a matrix.

Further, the numerical representation of the two or more elements may be mapped to a numerical representation of a predefined size related to the numerical representation of the two or more elements. This may be referred to as padding. Data-driven model(s) may require data input of a predefined size. Hence, padding may allow for processing of input data of irregular size by the generative data-driven model. Padding may include concatenating a numerical representation independent of the input data with the numerical representation of the two or more elements to generate the numerical representation of predefined size related to the numerical representation of the two or more elements. The numerical representation independent of the input data may be indicative of a zero.

Further, the encoder input 624 may apply positional encoding 604. Applying positional encoding 604 may refer to adding a positional factor to the embedded input obtained via input embedding. Applying positional encoding 604 may comprise mapping the numerical representation of the predefined size related to the numerical representation of the two or more elements to a numerical representation of the two or more elements and a relation between the two or more elements. Preferably, the input data may specify a sequence of elements. The positional factor pₚₒₛ may be indicative of the position of the elements within the sequence. For example, the positional factor pₚₒₛ may be obtained based on the following equations:

$${p}_{pos} ( 2 i ) = sin ( \frac{pos}{{10000}^{\frac{2 i}{d}}} )$$

$${p}_{pos} ( 2 i + 1 ) = cos ( \frac{pos}{{10000}^{\frac{2 i}{d}}} )$$

where pos may refer to the position of the element within the sequence, i may refer to the dimension associated with the input embedding and d may refer to the dimension of the model, e.g. transformer decoder, transformer encoder or transformer encoder-decoder. This may be referred to as absolute positional embeddings. Alternatively, the positional encoding may be based on rotary positional embeddings (RoPE). Positional encoding is beneficial since it enables the processing of sequential data without requiring further dimensions indicating the position of each element. Followingly, the positional encoding 604 reduces the computational resources needed for embedding the input data. By passing the input data through the encoder input, the input data may be transformed into a second-rank tensor representing the sequence of elements. This second-rank tensor may be referred to as embedded input data. The embedded input data may be processed by the encoder block. The embedded input data may be provided to the layer normalization 608 by a residual connection. Multi-head self-attention 606 may be applied to the embedded input data. Multi-head self-attention 606 may comprise the two components multi-head and self-attention. Self-attention may be understood as being a filter applied to the embedded input data. By applying the filter to the embedded input data, the elements associated with the embedded input data contributing to the to be generated output data may be identified for generating the output data. Hence, the filter may represent the degree of contributing to the to be generated output data by the elements associated with the embedded input data. Applying the filter may be referred to as weighting the elements associated with the embedded input data. This is advantageous specifically regarding long sequences of elements. The filter may be learned and improved during the training by learning to identify the contribution of elements associated with the embedded input data. For example, in the partial sentence “I went to the bakery to buy a” the last word may be generated by the generative data-driven model such as the transformer encoder. The self-attention may focus the transformer encoder to attend to the word “bakery” and “buy” mostly to generate the word “bread”. Self-attention may refer to attention generated based on the input data. Hence, the filter may be determined based on the input data, preferably the embedded input data. The embedded input data may serve as query Q, key K and value V with respect to the self-attention operation. The self-attention may refer to attention based on the received input data. Hence, the filter may be calculated based on the following formula by inserting the respective tensors based on the embedded input data:

$$Attention ( Q , K , V ) = softmax ( \frac{Q {K}^{T}}{\sqrt{{d}_{k}}} ) V$$

where dₖ corresponds to the dimension of the key.

For improving the efficiency of the transformer encoder further, the multiple heads are used to apply the filter resulting in the multi-head self-attention 606. Multi-head self-attention 606 may comprise applying the filter to two or more elements of the embedded input data. Hence, the tensor may be split into two or more elements and the filter may be applied to the two or more elements separately by two or more heads according to the following equation:

$$head i = A t t e n t i o n ( Q {W}_{i}^{Q} , {KW}_{i}^{K} , {VW}_{i}^{V} )$$

with parameter matrices

$${W}_{i}^{Q} ∈ {ℝ}^{d \times {d}_{Q}} , {W}_{i}^{K} ∈ {ℝ}^{d \times {d}_{k}} , {W}_{i}^{V} ∈ {ℝ}^{d \times {d}_{V}}$$

where i may refer to the number of heads, dᵥ, d_{K} and d_{Q} may refer to the dimensions of the value, key and query.

The result of the two or more head may be concatenated according to the following equation:

$$MultiHead ( Q , K , V ) = Concat ( head 1 , … , {head}_{h} ) {W}^{0}$$

where W₀ ∈ [symbol] ^{hd}^{_{V}}^{×d} and h may refer to the number of heads.

The embedded input data may be transformed via the multi-head self-attention 606 into a context tensor. The context tensor may represent the sequence of elements and the relation between two or more elements of the input data. The context tensor may be a second rank tensor and/or may comprise one or more first rank tensor(s). After the multi-head self-attention 606 layer normalization 608 may be applied based on the context tensor and/or the embedded input data from the residual connection. Applying layer normalization 608 may refer to normalizing the context tensor. Normalizing the context tensor may lower the values of the entries of the context tensor. This reduces the computational cost associated with processing the context tensor. Further, it improves the training by contributing the loss to converge and preventing instabilities.

Layer normalization 608 may be followed by passing the context tensor to a feed-forward layer 610 again followed by layer normalization 612 based on the residual connection to the context tensor and/or the output of the feed-forward layer 610. The feed-forward layer 610 may be a feed-forward neural network. The feed-forward neural network may comprise of a plurality of fully connected neurons. Passing the context tensor through the feed-forward neural network may result in transforming the context tensor linearly. Additionally or alternatively, the neural network may comprise one or more activation functions such as a rectified linear unit (ReLU). Hence, the neural network may be configured for performing one or more non-linear operations to the context tensor and/or transforming the context tensor non-linearly. After the context tensor has been transformed and/or normalized by the feed-forward layer 610 and the layer normalization 612, the context tensor may be provided to one or more further encoder blocks 614. Having passed the context tensor through the feed-forward layer 610 may adapt the context tensor for the processing by a further attention layer of the one or more further encoder blocks 614 for applying a self-attention filter, preferably multi-head self-attention 606. The context vector after being transformed by the layer normalization 612 and the feed-forward layer 610 may be referred to as hidden state.

The encoder output 622 comprises of a linear layer 616 and a softmax layer 618. The linear layer 616 may transform the context vector into a logits vector. The linear layer may be fully-connected. The logits vector obtained by passing the context tensor through the linear layer 616 may be passed through the softmax layer 618. Passing the logits vector through the softmax layer 618 may refer to applying the softmax function to the logits vector. Applying the softmax function to the logits vector may result in a probability distribution of one or more elements corresponding to the sequence of elements in the input data. From the probability distribution based on predefined selection criteria, one or more elements may be chosen. The one or more chosen elements may be referred to as the one or more elements generated by the transformer encoder. The one or more generated elements may be provided to the encoder input for generating further one or more elements corresponding to the sequence of the input data and the one or more elements generated by the transformer encoder as described within the context of FIG. 8.

Hence, processing the numerical representation of the two or more elements and the relation between the two or more elements by the generative data-driven model may comprise at least one of: generating two or more numerical representations of the two or more elements and the relation between the two or more elements from the numerical representation of the two or more elements and the relation between the two or more elements; modifying the two or more numerical representation of the two or more elements and the relation between the two or more elements by applying a filter to the two or more numerical representations of the two or more elements and the relation between the two or more elements, wherein the filter may be configured to modify the contribution of the two or more elements to the numerical representations of the two or more elements and the relation between the two or more elements; concatenating the two or more numerical representations of the two or more elements and the relation between the two or more elements; mapping the concatenated numerical representation of the two or more elements and the relation between the two or more elements to a numerical representation of the output data; or a combination thereof.

In particular the encoder block may be configured to: split the numerical representation of the two or more elements and the relation between the two or more elements into two or more numerical representations of the two or more elements and the relation between the two or more elements; modify the two or more numerical representation of the two or more elements and the relation between the two or more elements by applying a filter to the two or more numerical representations of the two or more elements and the relation between the two or more elements, wherein the filter may be configured to modify the contribution of the two or more elements to the numerical representations of the two or more elements and the relation between the two or more elements; concatenate the two or more numerical representations of the two or more elements and the relation between the two or more elements; or a combination thereof. Applying self-attention may comprise modifying the two or more numerical representation of the two or more elements and the relation between the two or more elements by applying a filter to the two or more numerical representations of the two or more elements and the relation between the two or more elements, wherein the filter may be configured to modify the contribution of the two or more elements to the numerical representations of the two or more elements and the relation between the two or more elements. The filter may be obtained during training of the generative data-driven model. The filter may be obtained based on, in particular related to the input data. Multi-head self-attention may comprise generating two or more numerical representations of the two or more elements and the relation between the two or more elements from the numerical representation of the two or more elements and the relation between the two or more elements, modifying the two or more numerical representation of the two or more elements and the relation between the two or more elements by applying a filter to the two or more numerical representations of the two or more elements and the relation between the two or more elements, wherein the filter may be configured to modify the contribution of the two or more elements to the numerical representations of the two or more elements and the relation between the two or more elements and/or concatenating the two or more numerical representations of the two or more elements and the relation between the two or more elements.

The encoder output may be configured to map the concatenated numerical representation of the two or more elements and the relation between the two or more elements to a numerical representation of the output data. The numerical representation of the output data may be mapped to output data, eg by providing a vocabulary indicative of a relation between numerical representations and data of a type according to the input data. Additionally or alternatively, a decoding model may be used to map the concatenated numerical representation of the two or more elements and the relation between the two or more elements to a numerical representation of the output data. The decoding model may be trained to relate a numerical representation of data of a type according to the input data.

FIG. 7 illustrates an embodiment of a transformer decoder architecture e.g. of an decoder-only transformer or transformer-based model.

The transformer decoder comprises a decoder input 724, one or more Decoder blocks 720, 714 and a decoder output 722. The transformer decoder may be referred to as X-former. The transformer decoder architecture may correspond to the decoder architecture associated with the transformer encoder-decoder architecture independent of receiving one or more hidden states from the encoder of the transformer encoder-decoder. An example of transformer decoder architectures is the generative pretrained transformer (GPT).

The decoder input 724 may apply input embedding 702 and positional encoding 704 analogous to analogous to the input embedding 702 and the positional encoding 704 as described within the context of FIG. 6.

The Decoder block 720 may comprise the layer normalizations 708, the masked multi-head self-attention 706, the feed-forward layers 710 and/or the layer normalization 712. The embedded input data resulting from passing the input data through the decoder input 724 may be provided to the layer normalization 708 via a residual connection. Further, masked multi-head self-attention 706 may be applied to the embedded input data. Masked multi-head self-attention 706 corresponds to the multi-head self-attention 606 as described within the context of FIG. 6 with additionally masking a part of the embedded input data associated with elements later in the sequence than the element to be generated. Additionally or alternatively, the part of the input data associated with elements later in the sequence than the element to be generated may not be received and/or transformed into the embedded input data. Thus, the transformer decoder may be suitable for generating a subsequent element to a sequence, whereas the transformer encoder may be suitable for generating a missing element in within one sequence and/or between two or more sequences. Therefore, the transformer encoder may be configured for classification tasks. The transformer decoder may be configured for text generation. Masked multi-head self-attention may comprise applying a filter obtained based on elements of the sequence of the input data appearing previously to the to be generated part of the sequence. Similar to the transformer encoder as described within the context of FIG. 6, a context tensor may be generated by applying the masked multi-head self-attention 706 and the layer normalization 708. The context tensor may be provided to the layer normalization 712 via a residual connection. Further, the feed-forward layer 710 and the layer normalization 712 may be analogous to the feed-forward layer 610 and the layer normalization 612 as described within the context of FIG. 6. The context tensor may be provided to one or more further decoder blocks 714.

The decoder output 722 may comprise of a linear layer 716 and a softmax layer 718. The linear layer 716 and the softmax layer 718 may be analogous to the linear layer 616 and the softmax layer 618 as described within the context of FIG. 6.

FIG. 8 illustrates an embodiment of a transformer encoder-decoder architecture e.g. of an encoder-decoder transformer or transformer-based model. The transformer encoder-decoder may comprise the encoder input 840, the one or more encoder blocks 838, 828, the decoder input 846, the decoder block 842 and the decoder output 844. The encoder input 840 may correspond to the encoder input 624 of FIG. 6. The one or more encoder block 838, 828 may correspond to the one or more encoder blocks 620, 614 of FIG. 6. The decoder input 846 may correspond to the decoder input 724 of FIG. 7.

The architecture described with respect to FIG. 8 may allow that the transformer encoder-decoder may receive and process input data at the encoder input 840 and the one or more encoder blocks 838, 828 and the decoder block 842 and the decoder output 844. Based on the input data, the transformer encoder-decoder may generate output data part by part or sequentially. The sequentially generated output data may be provided to and/or may be processed by the decoder input 846, the one or more decoder blocks 842, 806 and the decoder output 844. Preferably, a sequence may be provided to the encoder input 840 and after having generated at least a part of the output data, the decoder input 846 may be provided with at least the part of the elements of the output data already generated. By doing so, the next elements of the output data may be generated with a higher accuracy by taking the input data and the generated output data into account since more data is received by the transformer encoder-decoder may be received over time.

Because of the transformer encoder-decoder architecture, the transformer encoder-decoder may be configured for transforming a sequence into another representation of the sequence. An example for transforming one sequence into another representation may be translation of one sentence into another language. A plurality of transformer encoder-decoders may be used such as BART, T5 or the like.

In an embodiment, the layer normalization 836, 812 may be applied prior to the masked multi-head self-attention 834, multi-head self-attention 814 and/or the feed-forward layer 802 in the transformer decoder, the transformer encoder and/or the transformer encoder-decoder. By doing so, the computational resources for applying the multi-head self-attention 814 and/or the feed-forward layer 802 to the embedded input data and/or the context tensor may be decreased as the entries of the respective tensors may be lower after normalization.

In an embodiment, the decoder output 844 may comprise of a classification neural network, further feedforward layers, convolutional layers, fully connected layers or the like. For example, the transformer encoder-decoder may be configured for choosing between a plurality of options. For this purpose, the transformer encoder-decoder may be provided with three different input data sets and may classify the context vectors obtained from the one or more decoder blocks 842 via one or more linear layers. Followingly, the architecture may be extended depending on the use case to be solved.

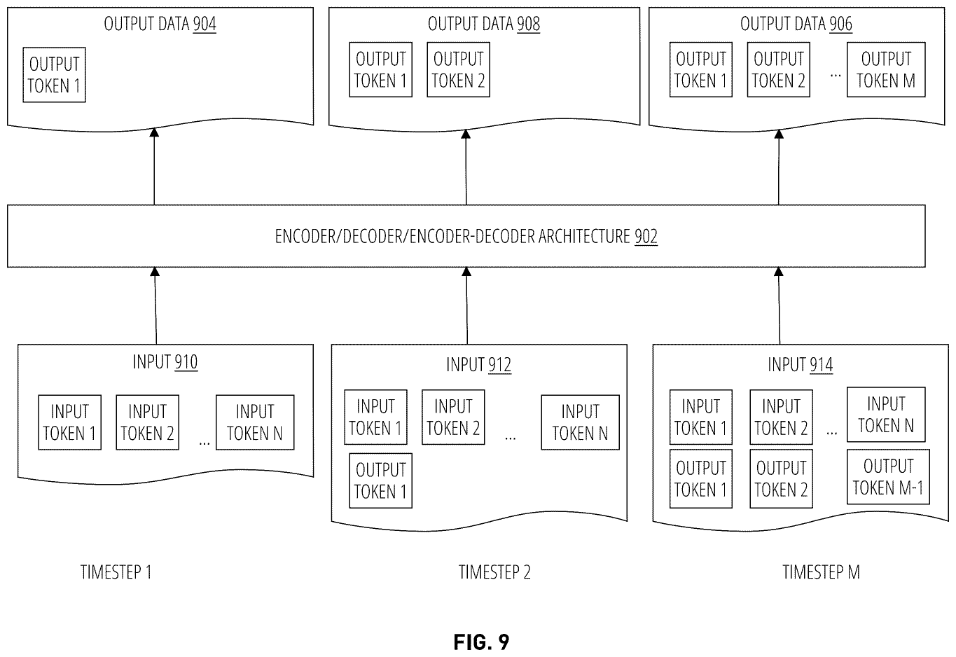

FIG. 9 illustrates an embodiment of training and/or deploying the transformer encoder, the transformer decoder and/or the transformer encoder-decoder.

The encoder/decoder/encoder-decoder architecture 902 may correspond to the transformer decoder, the transformer encoder and/or the transformer encoder-decoder as described within the context of FIG. 6-FIG. 8.

The output data generated by the encoder/decoder/encoder-decoder architecture 902 may comprise of one or more elements, in particular a sequence of elements. The previously generated elements of the output data may be provided as input for generating the next element in the sequence of the output data.

The input data may comprise of N elements, in particular input tokens. An input token may be a token dedicated to be inputted into a data-driven model such as the transformer decoder, the transformer encoder or the transformer encoder-decoder. The output data to be generated may comprise of M elements. The encoder/decoder/encoder-decoder architecture 902 may generate one element of the output data based on receiving the input data and optionally previously generated elements of the output data at a timestep. Hence, for generating M elements M time steps are required. A time step comprises of providing input 910, 912, 914 to the encoder/decoder/encoder-decoder architecture 902 and receiving output data 904, 908, 906 from the encoder/decoder/encoder-decoder architecture 902. In a first timestep, the input 910 may comprise of N input tokens. The N input tokens may be associated eg with N words, stems or endings. Preferably, the N input tokens may specify a question. One or more input tokens may specify the beginning of the sequence of tokens and/or the end of the sequence of tokens. The input 910 may be processed by the encoder/decoder/encoder-decoder architecture 902. Based on the input 910 at least a part of the output data 904 may be generated. The at least a part of the output data may comprise a first output token. In the next timestep, the generated first output token may be provided together with the input 912. Specifically, where the input 912 may be received by a transformer encoder-decoder the input tokens may be received at the encoder input 840 and the first output token may be received at the decoder input 846. Where the input 912 may be received by the transformer encoder, the input 912 may be received by the encoder input 840 and analogously regarding the transformer decoder and the decoder input 846. Based on the input 912, the output data 908 comprising the first output token and a second output token may be generated. Generating the output data 908 based on the input 912 may refer to generating the second token based on the first token and the N input tokens, wherein the first token may have been generated based on the N input tokens. This process may be repeated until the last token in the sequence of the output data 906 may be generated. Preferably, the last token may be an end token. The end token may terminate the generation of a further output token.

Similarly, to the data processing during deployment of the encoder/decoder/encoder-decoder architecture 902, the encoder/decoder/encoder-decoder architecture 902 may be trained. The training data set may comprise a plurality of sequences comprising a plurality of elements. The sequences may be associated with the input data and/or the output data. Additionally or alternatively, the sequences may be independent of the input data and/or the output data. For example, where the input data and the output data may refer to chemical compositions represented via text, the training data set may comprise sequential text data independent of chemical compositions. In this example, the training data set may comprise sequences of words originating from a conversation. In an embodiment, the training data set may comprise at least partially input data sets and/or output data sets.

The training may be initialized by initializing the encoder/decoder/encoder-decoder architecture 902. In an embodiment, the parameters associated with the encoder/decoder/encoder-decoder architecture 902 may be initialized randomly. Additionally or alternatively, the input embedding of the encoder/decoder/encoder-decoder architecture 902 may be obtained by training a CBOW model or a skip gram model as described within the context of FIG. 5. The trained embedding layer may be used during training. The parameters associated with the embedding layer may be kept constant and/or may be updated after a predefined number of training epochs. By doing so, the number of parameters to be updated is lower enabling a faster and less computational resources-consuming training. Further, the accuracy associated with the embedding layer may be constant and/or may be increased by avoiding error compensation in relation to the just initialized encoder/decoder/encoder-decoder architecture 902.

During the training of the encoder/decoder/encoder-decoder architecture 902, at least a part of the sequences of the training data set may be provided to the encoder/decoder/encoder-decoder architecture 902 one by another and one or more elements may be generated based on the sequences of the training data set one by another. The elements generated based on the sequences may follow the elements of the parts of sequences the encoder/decoder/encoder-decoder architecture 902 may have been provided with. The generated one or more elements may be compared to the one or more elements following the at least a part of the sequences provided to the encoder/decoder/encoder-decoder architecture 902 as specified by the training data set. Hence, during the training the encoder/decoder/encoder-decoder architecture 902 may generate a guess on the next element and the guess on the next element in a sequence may be compared to the ground truth specifying the actual next element according to the training data set. Based on the guess on the next element and the ground truth a loss may be determined. The loss may define the similarity between the guess on the next element and the ground truth. The loss may be determined by forming a vector dot product between the token associated with the one or more elements and the token associated with the ground truth. A loss unequal to zero may result in updating the parameters associated with encoder/decoder/encoder-decoder architecture 902. Preferably the parameters associated with the encoder/decoder/encoder-decoder architecture 902 may be independent of the embedding layer. For example, the parameters associated with the encoder/decoder/encoder-decoder architecture 902 may be weights of the neurons of the encoder/decoder/encoder-decoder architecture 902.

Based on the determined loss, backpropagation may be applied to determine the gradients associated with the parameters of the parameters associated with encoder/decoder/encoder-decoder architecture 902 to lower the loss. According to the determined gradients, the parameters associated with the encoder/decoder/encoder-decoder architecture 902, preferably the weights of the neurons associated with the encoder/decoder/encoder-decoder architecture 902, may be updated by using a gradient descent algorithm.

The training data set may be unlabeled. The sequences of elements within the training data set may inherently comprise the ground truth for determining the loss with respect to the one or more elements generated during the training of the encoder/decoder/encoder-decoder architecture 902. Hence, the encoder/decoder/encoder-decoder architecture 902 may be trained self-supervised. This is advantageous since time and resources for creating a labeled training data set may be saved. Furthermore, this enables the usage of large training data sets associated with a size of several tera bytes. Consequently, the data-driven model may be accurate in generating elements of a sequence. In addition, the large training data set enables few shot predictions or even zero shot predictions. Hence, the generative data-driven model(s) trained as described above are versatile contributing to saving resources needed for training and/or hosting a plurality of purpose-driven models such as convolutional neural networks. The training described above may be referred to as pretraining. Pretraining may refer to training a generative data-driven model based on data with a plurality of contexts

The generative data-driven model may be configured for performing few shot or even zero shot predictions with respect to a plurality of use cases after pretraining. The performance of the data-driven model may be increased further by additional training referred to as finetuning. Finetuning may refer to training a pretrained data-driven model for a concrete task, e.g. by providing task instructions to the pretrained data-driven model and adapting the parameters of the pretrained data-driven model to decrease the distance of the generated output data by the pretrained data-driven model in response to receiving the task instructions from predefined output data corresponding to the provided task instructions.

Models based on the architecture according to FIG. 6 to FIG. 8 and/or pretrained generative data-driven model(s) and/or finetuned data-driven model(s) may be referred to as large language models. Examples of large language models include Llama models, Mistral models, GPT models, BERT models or the like. Such models have been tested. Testing data-driven model(s), in particular pretrained and/or finetuned data-driven model(s), may include comparing output data generated by the one or more data-driven model(s) in response to receiving the input data with target data, e.g. obtained from domain experts. These domain experts may be a current bar for performing tasks the data-driven model(s) may be parametrized and/or trained for. The target data may specify output data desired to be generated in response to receiving the input data.

FIG. 10 illustrates another embodiment of input embedding, e.g. for generative data-driven models or machine-learning architectures using an embedding layer such as a transformer encoder, transformer decoder or transformer encoder decoder architecture.

Where the sequence of elements associated with the input data, preferably comprised in the input data, may be of one type. For example, a type of input data may be text where the elements may be associated with at least a part of a word, a punctuation character, a start token specifying the beginning of one or more sequences associated with the input data and/or the end token. In another example, the input data may be at least partially numerical. Hence, the input data may comprise a plurality of numbers. Numerical input data may be for example tabular data. Tabular data may specify one or more rows and/or one or more columns. Hence, the tabular data may comprise one or more cells, wherein the cells may be associated with one or more numerical values.

Numerical input data may require a different embedding than text input data. Input embeddings for numerical input data may comprise a token embedding, a positional embedding, a column embedding, a row embedding or a combination thereof.

Applying a token embedding to one or more elements, in particular tokens associated with the input data may result in a machine-processable representation associated with the one or more elements, in particular tokens. Applying the token embedding to one or more elements may refer to passing the one or more elements through the embedding layer, e.g. as described within the context of FIG. 5. Hence, token embeddings may specify the one or more elements, in particular tokens in a machine-processable representation. For example, the token embedding may transform a numerical value into a vector. This is advantageous since this representation can be enriched by further information such as the position of the token within the sequence and/or within a table associated with the sequence of tokens. The positional embedding may be analogous to the positional embedding as described within the context of FIG. 6, FIG. 7, FIG. 8. Where the input data may be tabular data, column embedding may be applied. Applying a column embedding to one or more elements, in particular tokens associated with the input data may result in a machine-processable representation specifying the location of the one or more elements within a table 1002, preferably within the columns of the table 1002. Applying the column embedding may refer to adding a column factor to the input data embedded via token embeddings, in particular the embedded input data. The column factor may be the same for elements associated with the same column and/or may differ between two or more elements associated with different columns. Analogous, row embeddings may be applied where the input data may be tabular data. Applying a row embedding to one or more elements, in particular tokens associated with the input data may result in a machine-processable representation specifying the location of the one or more elements within a table 1002, preferably within the rows of the table 1002. Applying the row embedding may refer to adding a column factor to the input data embedded via token embeddings, in particular the embedded input data. The row factor may be the same for elements associated with the same row and/or may differ between two or more elements associated with different rows.

In an embodiment, input data may be at least partially numerical and at least partially text. Hence, the input data may comprise two or more types of data. A type of data may refer to a modality. Followingly, different embeddings may be applied to the input data. To parts of the input data comprising text the input embedding referred to in FIG. 6, FIG. 7 to FIG. 8 may be applied. To parts of the input data being numerical token embeddings, positional embeddings, column embeddings and row embeddings may be applied. Further, segment embeddings may be applied to the input data independent of the type of input data. The segment embedding may specify the type of input data one or more elements may be associated to. For example, if the input data comprises of text and numbers, the input data may comprise of two types of input data. Applying the segment embedding to the input data may refer to adding a segment factor to the input data, preferably the embedded input data and/or the input data after having applied the token embedding. The segment factor may specify the type of data associated with the one or more elements. The segment factor may be the same for one or more elements associated with the same type of input data and/or may differ between two or more elements associated with different types of input data.

Applying the token embedding, the positional embedding, the segment embedding, the column embedding, the row embedding or a combination thereof may result in embedded input data and/or may be the output of any one of the encoder input 624, encoder input 840 or decoder input 724, decoder input 846. The data obtained by applying the token embedding, the positional embedding, the segment embedding, the column embedding, the row embedding or a combination thereof may be processed by the encoder block 620, encoder block 838, Decoder block 720, decoder block 842, encoder output 622, decoder output 722, decoder output 844.

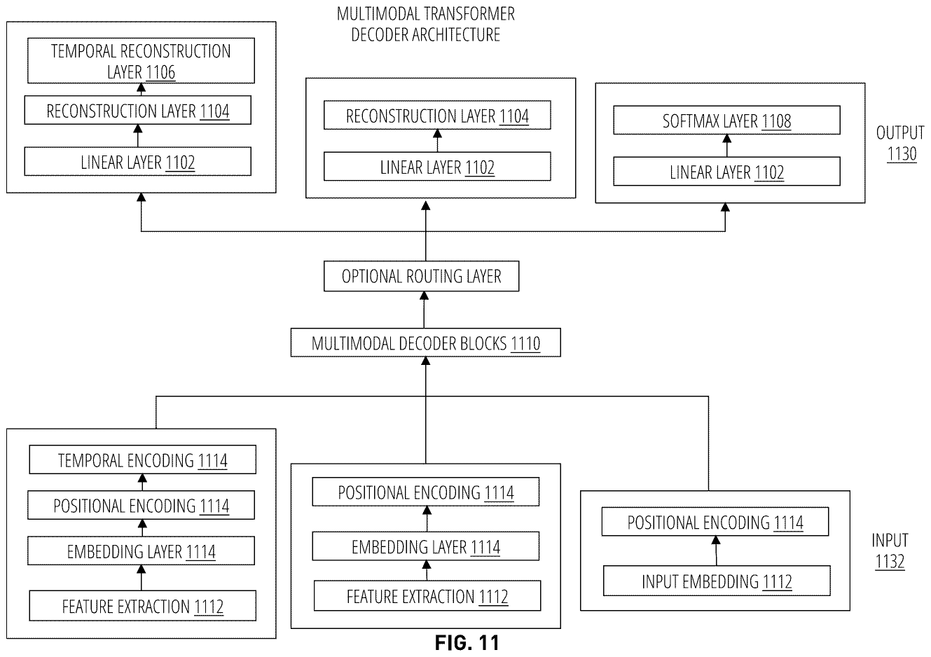

FIG. 11 illustrates an embodiment of a multimodal generative data-driven model having a transformer decoder architecture e.g. of an multimodal decoder-only transformer(-based) model configured to process more than one modality (e.g. text, image, video, audio) such as GPT4o, GPTo1 or later versions. The example multimodal generative data-driven model may have about 230 billion (trainable) parameters. The example multimodal generative data-driven model may comprise encoders for different modalities, e.g. at least one of the following: a text encoder configured to encode text data into the latent space (or embedding space) used by the model, like described above in conjunction with FIG. 6, FIG. 7, FIG. 8, which may be a text encoder comprising an input embedding layer 1112 e.g. configured to convert input tokens into text embedding (or vector representation) and a positional encoding layer 1114 configured to add positional data (e.g. related to the order of tokens that were embedded) to the embeddings; an audio encoder configured to encode audio data into the latent space used by the model as an audio embedding, wherein the audio encoder may comprise a feature extraction layer 1112 configured to extract features related to the essential characteristics of the audio data (such as Mel-frequency cepstral coefficients (MFCCs) or spectrograms), an embedding layer 1114 configured to transform the extracted features into the latent space and a positional encoding layer 1114 configured to add positional data (e.g. related to the order of tokens that were embedded, e.g. related to the temporal order of the audio data) to the embedding; an image encoder configured to encode image data (e.g. related to a drawing or figure such as a P&ID or another two or more dimensional representation of a chemical production process) into the latent space used by the model as an image embedding, wherein the image encoder may comprise a feature extraction layer 1112 configured to extract features related to the essential characteristics of the image data, an embedding layer 1114 configured to transform the extracted features into the latent space and a positional encoding layer 1114 configured to add positional data (e.g. related to the spatial relationship of the extracted features in the image data) to the embedding. For instance, the feature extraction layer 1112 may comprise a convolutional neural network (CNN) to extract relevant features or a Versatile Vision Encoder (VCoder); and/or a video encoder configured to encode video data.

An encoder may be assigned to an input data depending on the type of input data or data type, e.g. pdf, png, docx, etc. or depending on meta-data associated with the input data, wherein the metadata is related to or indicates the respective encoder.

The encoders may be trained separately for encoding their respective modalities and then a conversion layer may be added to the encoders that may be trained separately to convert the embeddings into the common latent space of the multimodal model. For instance, a text encoder, multimodal decoder blocks 1110 and text decoder may be trained separately like a unimodal text large language model (e.g. on textual general purpose data) or may be taken from a pre-trained text large language model as described in conjunction with FIG. 6, FIG. 7, FIG. 8. The furthers encoders (e.g., image encoder, video encoder, audio encoder) may be pre-trained on large (general-purpose) datasets specific to its modality (e.g. MNIST, Common Objects in Context (COCO) or Visual Genome for image training data; Common Voice or AudioMNIST for audio training data; YouTube-8M or In Vid FIVR-200k for video training data) which may allow the encoders to learn to extract meaningful features from their respective inputs. After pre-training, conversion layers may be added to map the embeddings from each encoder into the common latent space used by the multimodal model, which may be the latent space of the text model es described above. A conversion layer may comprise one or more linear layers, attention layers, or other types of neural network layers configured to align the embeddings into the common latent space. A text encoder may comprise a text tokenizer such as SentencePiece using Byte Pair Encoding (BPE), which may allow for a robust, language-independent subword tokenization for handling multiple languages and out-of-vocabulary words. The SentencePiece method may start with an initial vocabulary consisting of all individual characters from the input text, including a special symbol to denote whitespace, and the BPE model may identify the most frequent contiguous pairs of characters in the text and merges them into subword units. This process may be repeated iteratively until a desired vocabulary size is reached.

An audio encoder may comprise a Whisper model, which may be pre-trained on a large dataset of audio recordings and their corresponding transcriptions, enabling it to generate detailed auditory embeddings that capture the semantic content of audio. For instance, audio data may be converted to raw waveform audio at a 24 kHz sampling rate, normalized to the range [−1, 1], and split into 250 ms frames (e.g. 6000 samples per frame). The audio encoder may comprise a feature extraction layer comprising a 1D convolution layer (e.g. with 32 channels and a kernel size of 7). The audio encoder may comprise an embedding layer comprising e.g. four convolutional blocks, each of which may comprise a residual unit with two convolutions (e.g. with kernel size of 3) and a skip-connection, as well as at least one down-sampling layer (e.g a strided convolution with strides 2, 4, 5, 8). The audio encoder may comprise a positional encoding layer comprising a sequence modeling component (e.g. two-layer LSTM) for capturing temporal dependencies. The audio encoder may comprise a conversion layer comprising a convolutional layer to generate the embedding in the latent space of the multimodal generative data-drive model. The encoder may utilize Exponential Linear Unit as an activation function and Weight Normalization. The encoder output may be quantized prior to passing it tot he multimodal decoder blocks 1110 using Residual Vector Quantization (RVQ) which may enhance efficiency, e.g. by selecting a codebook vector in a pre-determined codebook closest (e.g. with reference to a Euclidean distance metric) to the embedding provided by the audio encoder, wherein the codebook may be of a size similar to the text encoding vocabulary. After finding the closest codebook vector, a residual vector may be computed as the difference between the high-dimensional vector and the closest codebook vector. This residual vector may then also be quantized using subsequent codebooks in a similar manner, refining the quantization process, so that the resulting vectors used as input for the decoder blocks 1110 may be of a dimension of codebook size times number of codebooks used, wherein the codebook size may be chosen so that the dimension of the vector used as input for the decoder blocks is of a size similar to the text encoding vocabulary. A text encoder may comprise Qwen2-0.5B, which may be pre-trained on a large set of general-purpose text data.

An image encoder may comprise Contrastive Language-Image Pre-training (CLIP) model, wherein CLIP may be pre-trained on a large dataset of images and their corresponding textual descriptions, allowing it to generate image embeddings that capture the semantic content of images. An image encoder may comprise an image tokenizer, which may comprise or based on an encoder of a vector-quantized variational autoencoder (VQ-VAE), which may be trained to encode image data into a number of codebook vectors using a codebook size similar to the codebook size that may be used by the audio encoder (e.g. about 65,000, which may enable using an optical character recognition method for text extraction from the image data). The image decoder may then comprise the decoder of the VQ-VAE. Prior to processing image data may be resized to a fixed resolution and pre-processing such as normalization and data augmentation techniques like random cropping, flipping, and rotation may be applied, which may enhance the model's robustness. For instance, image data may be embedded by convolutional layers of a feature extraction layer, e.g. as a three dimensional tensor, wherein the convolutional layers are configured to extract hierarchical features from the image data, capturing e.g. both low-level details (e.g., edges and textures) and high-level semantics (e.g., objects and scenes). The feature extraction layer may comprise one or more pooling layers configured to reduce the spatial dimensions of the vectors generated by the convolutional layers, e.g. Max pooling, average pooling or global pooling. The generated vectors may be passed to an embedding layer, which may comprise one or more fully connected layers to provide a fixed-size embedding. A positional encoding layer of an image encoder may comprise one or more attention layers.

A conversion layer may be applied to transform the vector representation generated so far by the different encoders into a common latent space. Alternatively, a fusion layer may be applied, configured to integrate the features from the different modalities into a unified embedding. A fusion layer may comprise a feature alignment layer configured to transform the features into a common space where they can be compared and combined, e.g. using normalization and transformation. A fusion layer may comprise one or more attention layers, e.g. self-attention and/or cross-attention layers, A fusion layer may comprise, e.g. as a final layer, a combination layer applying e.g. concatenation, summation of a neural network alike a conversion layer, to generate and provide embedding or vector representations in the common latent space of the multimodal generative data-driven model.

A flag may be added to the end of the embedding, which may be configured to indicate whether the embedding or vector was generated by the generative model or received as input data. The flag may be an additional 0 or 1 at the end of the embeddings or vectors. A modality-specific position encoding indicating the position within a specific modality and/or a time-based encoding indicating the temporal position may be concatenated to the embedding, which may enhance alignment of the different modalities.

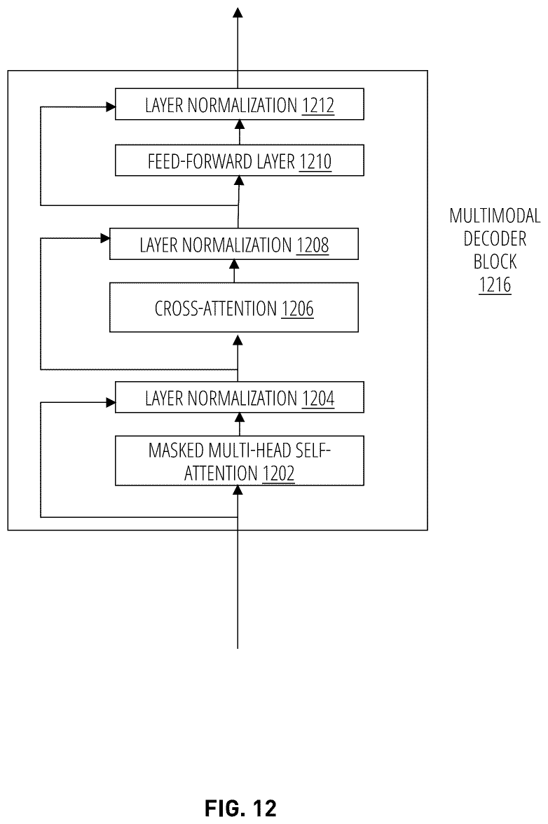

The multimodal generative data-driven model may comprise one or more multimodal decoder block 1110 as illustrated in FIG. 12, wherein a multimodal decoder block may comprise a cross-attention layer (which may be added after pre-training e.g. between a masked multi-head self-attention and a feed-forward layer of the decoder block as described in conjunction with FIG. 6, FIG. 7, FIG. 8). A cross-attention layer may be configured to attend to the relevant parts of the encoded input sequences across multiple modalities. A cross-attention layer may be configured to integrate information from different modalities by attending to relevant parts of the respective input sequences. It may be structured like a self-attention layer described in conjunction with FIG. 6, FIG. 7, FIG. 8. However, while in the self-attention layer, queries, keys, and values come from the same input sequence, in a cross-attention layer, the queries may come from the output of the previous self-attention layer, while the keys and values come from the respective encoders output. In the cross-attention layer, an attention score may be calculated by taking the dot product of the queries with the keys, followed by a scaling factor. This may result in a matrix of attention scores that indicate the relevance of each key to each query. The attention scores may be passed through a softmax function to obtain the attention weights, which may represent the importance of each key-value pair for each query. The attention weights may be used to compute a weighted sum of the values. This may result in a context vector that captures the relevant information from the encoder for each query. The context vectors may then be passed through a linear layer to project them into the desired output space. Cross-attention may be represented by:

$$C - Attention ( Q , K , V ) = softmax ( \frac{Q {K}^{T}}{\sqrt{{d}_{k}}} ) V$$

where Q may represent the queries, K the keys, V the values, and dₖ may be the dimensionality of the keys. As each modality (e.g., text, image, audio) may have its own encoder that processes the input data and generates embeddings, these embeddings may be concatenated and then used as keys (K) and values (V) in the cross-attention layer.

The output of the multimodal decoder blocks 1110 may be passed to respective decoders for different modalities. An optional routing layer trained e.g. via supervised training, may enhance the efficiency of the multimodal generative data-driven model to decide which output modality is required for a given query. The optional routing layer may be configured to decide which decoder to activate in a multimodal model. It may comprise one ore more of the following: A linear layer; a multilayered perceptron comprising multiple layers which may allow to learn more complex relationships between the inputs and the decoders; an attention-based routing layer configured to identify the relevant parts of the inputs and make the decision on which decoder to activate; a gating mechanism could be used to make the decision on which decoder to activate, e.g. using sigmoid or softmax function to decide which decoder to activate based on the inputs; and/or a Recurrent Neural Network (RNN) or Long Short-Term Memory (LSTM) network, which may enhance the ability to resolve temporal dependencies in the inputs and the model needs to learn which modalities are relevant at different time points.

A text decoder may comprise a linear layer followed by a softmax layer as described with reference to FIG. 7. An image decoder may comprise a reconstruction layer, e.g. a decoder of a VQ-VAE. An audio and/or video encoder may further comprise a temporal reconstruction layer 1106 configured to bring the generated output tokens into a correct temporal order. A decoder per modality may comprise or be based on a decoder corresponding to the respective encoder used in the multimodal generative data-driven model.

The multimodal generative data-driven model may be trained to generate no output tokens for specific modalities, so that no output in these modalities is generated. This may be used as an (e.g. alternative) routing mechanism.

The multimodal generative data-driven model may be trained using pre-training of a number of its layers, a multimodal integration training and a post-training or fine-tuning. The encoder and/or decoder of a respective modality may be pre-trained together on respective general-purpose data set comprising data of the respective modality, wherein the pre-training is performed like it would be performed for an encoder, decoder of a respective unimodal modal. For instance, the text encoder, optionally the decoder blocks (without cross-attention layer), and text decoder may be pre-trained on a general-purpose dataset comprising natural language. Pre-training may comprise a multimodal pre-training over multiple modalities using respective data sets, e.g. image data and respective descriptions as described above. For instance, pre-training may comprise an interleaved text and image pre-training utilizing a dataset of interleaved text and image data that may be scraped from the internet. A multimodal pre-training may enhance the models ability to generate unified embeddings in a unified latent space across the respective modalities. Multimodal pre-training may comprise a step of training only the weights of a conversion layer or fusion layer on a smaller data set, while other the weights of the other layers remain unchanged (e.g. are frozen), which may enhance the model's ability to generate unified embeddings. In pre-training the weights associated with an encoder and/or decoder of a specific modality may be trained while the weights of all other components remain unchanged (or unchangeable/frozen). The tokenizer may be trained likewise while the remaining weights remain unchanged or are frozen. For instance, autoregressive prediction may be performed on tokens of audio data, which may enhance the model's ability to generate embeddings of audio data and to decode processed embeddings into audio output in an audio decoder. Suitable audio data may e.g. be obtained from online podcasts or the like on which a voice activity detection may be applied to filter audio data.

Post-training or fine-tuning may comprise supervised training e.g. using labeled data sets. For instance, instruction fine-tuning may be performed using labeled training data comprising comprising pairs of instructions provided to the model (e.g. task instructions) and desired output which may improve the model's ability to generate the output in a modality as requested in the instruction. Post-training or fine-tuning may e.g. comprise Direct Preference Optimization (DPO) using data from user sessions to align the model's outputs with user preferences, which may involve optimizing the model's parameters to satisfy user preferences using a binary cross-entropy minimalization. Post-training or fine-tuning may e.g. comprise chain-of-though or reasoning training e.g. like a stepwise internalization method which may enhance the model's reasoning abilities. For instance the multimodal generative data-driven model may initially be trained to generate explicit chain-of-thought reasoning steps; then intermediate reasoning steps are removed during training, so that the model may internalize the reasoning process. This training may involve multiple stages, each removing more of the explicit reasoning steps.

In multimodal integration training, the multimodal generative data-driven model only certain weights may be allowed to be adapted, e.g. weights of cross-reference-layers, routing layer, fusion layer and/or conversion layer, which may enhance the multimodal generative data-driven model's ability to align the different modalities and align the generated outputs with provided user instructions, queries or task instructions. During training also the no output token generation may be trained. A multimodal integration training may be performed before and/or after above described fine-tuning, e.g. parts may be performed before said fine-tuning and other parts after said fine-tuning. It may be based on a generated data set across different modalities for example using more specialized models, e.g. trained for specific tasks such as text to image like DALL-E. So, the input and output of the more specialized model may be used as labeled training data.

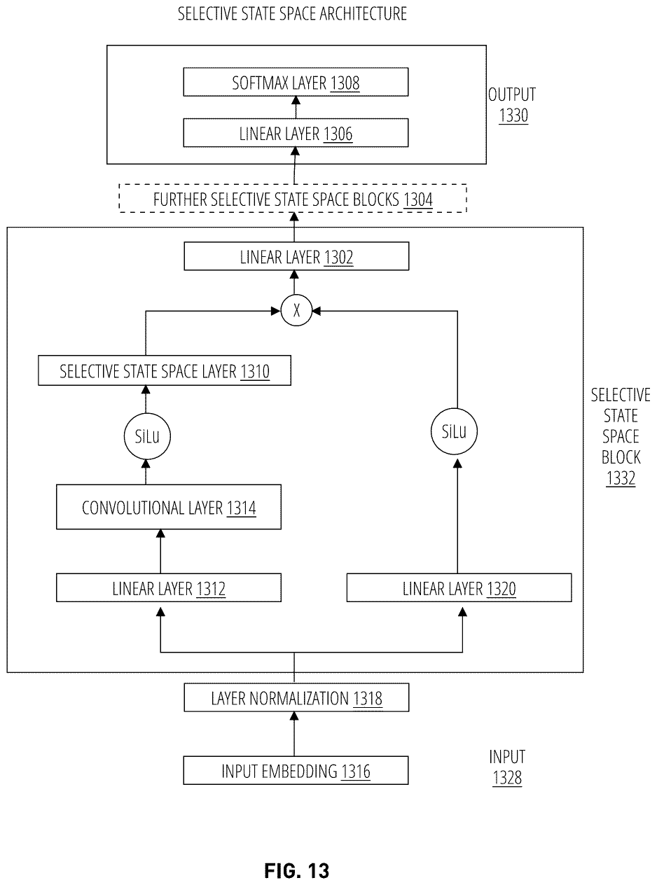

FIG. 13 illustrates an embodiment of a selective space state sequence model e.g. utilizing a Mamba architecture, that may be used as a generative data-driven model. A selective state space model architecture may enhance inference speed in relation to a transformer based model.

The selective state space architecture with its layered structure may be similar to the transformer decoder architecture discussed in relation to FIG. 7. However, instead of decoder blocks selective state space blocks 1332, 1304 are stacked. Selective state space block 1332 may be based on a selective space state sequence model (S6).

An input token may be linearly projected via linear layer 1312, 1320 into an expanded latent space (which may allow to capture more information during processing in the selective state space layer 1310), followed by a convolution via a convolutional layer 1314 and a non-linear function (e.g. a sigmoid linear unit (SiLu) or swish activation function). The convolution before the selective state space layer 1310 may prevent independent token calculations. The selective state space layer 1310 performs a selective state space operation. Further, a learnable skip connection may be provided via linear layer 1320, this may use a linear transformation to map the input to the output, similar to a residual connection in a transformer model this may help to mitigate vanishing gradient effects.

A selective state space layer 1310 may be a linear recurrent network that selectively process data based on the input token, which may allow to focus on relevant data and discard irrelevant data. For instance in each step a separate weight vector may be determined based on the respective input token. The determined weight vector may then be used in a selective scan.

A selective state space layer 1310 may be used in a convolutional mode e.g. for parallelizable training and a recurrent mode for near-constant time generation of output data. A state space operation may be based on solving the state and output equations, wherein a state equation may describe how a state changes based on how the input influences the state and an output equation may describe how the state is translated to the output. Further how the input influences the output may be represented by a learnable linear transformation, e.g. a matrix D, used in a learnable skip connection.

The state equation for a hidden state may be (in discretized form):

$${h}_{k} = A {h}_{k - 1} + B {x}_{k}$$

The output may be expressed by (in discretized form):

$${y}_{k} = C {h}_{k}$$

This discretized space state model may be unfolded into a recurrent form similar to a recurrent network, exemplifying that a selective state space model may be or comprise a linear recurrent model. However, here matrices A, B, and C may also be used as a kernel of a convolution of the state space model. Kernel K for this may e.g. be:

$$K = ( {CA}^{2} B , CAB , CB )$$

which may allow to determine an output:

$${y}_{k + 1} = {CA}^{2} B {x}_{k - 1} + {CABx}_{k} + {CBx}_{k + 1}$$

So, in this representation of the state space model training may be performed in a parallel manner like in convolutional neural networks.

Matrix A may be a matrix that represents recent tokens well and decays older tokens and may be initialized using HiPPO:

$${A}_{n , k} = \{ \begin{matrix}{( 2 n + 1 )}^{1 / 2} {( 2 k + 1 )}^{1 / 2} \\ n + 1\end{matrix}$$

where every entry below the diagonal is set to 0. This may allow to create a long-term memory for the selective state space model.

For a Selective state space block 1332, the matrices B and C as well as the step size A used for discretization of the matrices may be dependent on the input token and may be trained during training, so that for each input token different matrices B and C are determined, which may enhance the content-awareness and may act similar to a multi-head self-attention in a transformer model. However, unlike in space state models with fixed matrices A, B, and C, here the convolutional representation may not be easily determined. Hence, to operate the selective state space layer 1310 in convolutional mode a selective scan may be applied utilizing associative properties of the hidden states calculation, allowing parallel determination of the sequence in parts and iteratively combining them, so that parallel training may be used. Further reading and writing operations may be decreased by using kernel fusion of the described step size, the selective scan, and the multiplication with C.

Linear layer 1302 may project the generated output back into the same dimension as the input.

Selective state space blocks may be used together with transformer decoder blocks or mixture of expert blocks (e.g. decoder blocks wherein the feed-forward layer is exchanged for a gating network and a number of parallel feed-forward layers, wherein the gating network switches between the feed-forward layers depending on the input), which may allow leveraging advantages of the different architectures.

An example of the architecture of a selective state space block may be found in “Mamba: Linear-Time Sequence Modeling with Selective State Spaces” by Albert Gu and Tri Dao arXiv: 2312.00752v2 [cs.LG] 31 May 2024, which is incorporated herein by reference.

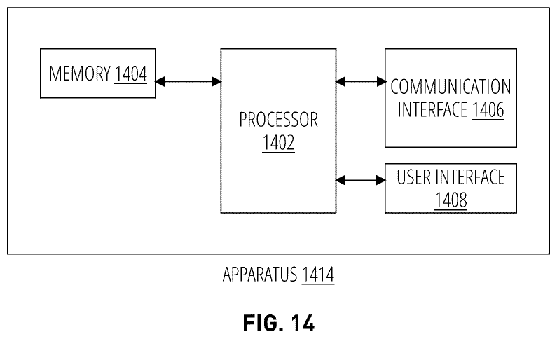

FIG. 14 shows a schematic block diagram of an example apparatus 1414 or computation apparatus according to an example aspect, which may for instance represent the apparatus according to the second example aspect. Apparatus 1414 may for instance be configured to perform and/or control or comprise respective means (e.g. at least one of memory 1404, processor 1402, communication interface 1406, user interface 1408) for performing and/or controlling the method according to the third and/or fourth example aspect. Apparatus 1414 may as well constitute an apparatus comprising at least one processor (1402) and at least one memory (1404) storing instructions that, when executed by the at least one processor, cause an apparatus, e.g. apparatus 1414 at least to perform and/or control the method according to all example aspects. Processor 1402 may for instance execute program code stored in memory 1404, which may for instance represent a readable storage medium comprising program code that, when executed by processor 1402, causes the processor 1402 to perform the method according an example aspect. Processor 1402 may for instance further control memory 1404 and/or further memories, the communication interface(s) 1004, the optional user interface 1408, e.g. a graphical user interface 1408. Processor 1402 (and also any other processor mentioned in this specification) may be a processor of any suitable type. Memory 1404 may be included in processor 1402 or memory 1404 may be fixedly connected to processor 1402, or be at least partially removable from processor 1402, for instance in the form of a memory card or stick. Memory 1404 may for instance be non-volatile memory. It may for instance be a FLASH memory (or a part thereof), any of a ROM, PROM, EPROM and EEPROM memory (or a part thereof) or a hard disc (or a part thereof). Memory 1404 may also comprise an operating system for processor 1402. Memory 1404 may also comprise a firmware for apparatus 1414. Memory 1404 may also for instance be a Random Access Memory (RAM) or Dynamic RAM (DRAM). It may for instance be used by processor 1402 when executing an operating system and/or computer program. Communication interface(s) 1406 may enable apparatus 1414 to communicate with other entities, e.g. another apparatus, such as a server providing operation data sets or operation data embeddings or a server providing a generative data-driven model or a user device or computer e.g. used by an operator and providing a user interface. The communication interface(s) 1004 may for instance comprise a wireless interface and/or wire-bound interface for instance to communicate with entities via an Intranet. User interface 1408 is optional and may comprise a display for displaying information to a user and/or an input device (e.g. a keyboard, keypad, touchpad, mouse, etc.) for receiving e.g. a query from an operator. Some or all of the components of the apparatus 1414 may for instance be connected via a bus. Some or all of the components of the apparatus 1414 may for instance be combined into one or more modules.

Example aspects, embodiments and examples of this disclosure provided above may allow an operator, easy, time-efficient, and reliable access to relevant operation data related to particular requested operations, such as operating an apparatus, controlling a process in a plant. Which may support an operator in safely and efficiently operating a plant while complying with (all) relevant regulations and guidelines.

The publication Prior Art Disclosure; Issue 684; paragraphs [1000] to [8005]; ISSN: 2198-4786; published: Feb. 12, 2024 will be regarded as Reference RF1, which is hereby incorporated by reference herein in its entirety. Preferably, the product is a chemical product as described in Reference RF1; paragraphs [1000] to [8005]. Preferably, the method/process described herein is further a method/process for the production of a product.

The converting step to obtain the product preferably comprises one or more step(s) as described below and can be performed by conventional methods well known to a person skilled in the art. The converting step preferably comprises one or more step(s) selected from: recycling, preferably depolymerizing, gasifying, pyrolyzing, and/or steam cracking; and/or purifying, preferably crystallizing, (e.g. solvent) extracting, distilling, evaporating, hydrotreating, absorbing, adsorbing and/or subjecting to ion exchanger; and/or assembling, preferably foaming, synthesizing, chemical conversion, chemically transforming, polymerizing and/or compounding; and/or forming, preferably foaming, extruding and/or molding; and/or finishing, preferably coating and/or smoothing.

In addition, the one or more step(s) are described in detail in Reference RF1; paragraphs [1000] to [8005].

The present disclosure has been described in conjunction with preferred embodiments and examples as well. However, other variations can be understood and effected by those persons skilled in the art and practicing the claimed subject-matter, from the studies of the drawings, this disclosure and the claims. Notably, in particular, any steps presented can be performed in any order, i.e. the present disclosure is not limited to a specific order of these steps. Moreover, it is also not required that the different steps are performed at a certain place or at one node of a distributed system, i.e. each of the steps may be performed at different nodes using different equipment/data processing.

The sequence of all method steps presented above is not mandatory, also alternative sequences may be possible. Nevertheless, the specific sequence of method steps shown as examples in the figures shall be considered as one possible sequence of method steps, e.g. for the respective embodiment described by the respective figure or an embodiment comprising at least some of the steps described by the respective figure.

In the present specification, any presented connection in the described embodiments is to be understood in a way that the involved components are operationally coupled. Thus, the connections can be direct or indirect with any number or combination of intervening elements, and there may be merely a functional relationship between the components.

As used herein “determining” may also include “initiating or causing to determine”, “generating” may also include “initiating and/or causing to generate”, “providing” may also include “initiating or causing to determine, generate, select, send and/or transmit”, and “obtaining” may also include “initiating or causing to determine, generate, select, retrieve and/or receive”. “Initiating or causing to perform an action” may include any processing signal that triggers a computing node or device to perform the respective action.

The term “comprising” or “including” is to be understood in an open sense, i.e. in a way that an object that “comprises an element A” may also comprise further elements in addition to element A. Further, the term “comprising” or “including” may be limited to “consisting of”, i.e. consisting of only the specified elements.

The indefinite article “a” or “an” is not to be understood as “one”, i.e. use of the expression “an element” does not preclude that also further elements are present. A single element or other unit may fulfill the functions of several entities or items recited in the claims. The mere fact that certain measures are recited in the mutual different dependent claims does not indicate that a combination of these measures cannot be used in an advantageous implementation or further elements may be included.

The expressions “A and/or B” and “at least one of: A or B” are considered interchangeable and meant to comprise any one of the following three scenarios: (i) A, (ii) B, (iii) A and B. More generally, the expression “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements, so the wording includes any combinations of the elements.

Providing in the scope of this disclosure may include any interface configured to provide data. This may include an application programming interface, a human-machine interface such as a display and/or a software module interface. Providing may include communication of data or submission of data to the interface, in particular display to a user or use of the data by the receiving entity.

Obtaining in the scope of this disclosure may include any interface configured to obtain or receive data. This may include an application programming interface, a human-machine interface such as a display and/or a software module interface. Obtaining may include communication of data or submission of data from the interface, in particular use of the data by the receiving entity. Any obtaining of data, data structures, data sets, or the like may comprise receiving the data, data structures, data sets, or the like from a server providing (e.g. hosting) a data base comprising the data, data structures, data sets, or the like.

Various units, circuits, entities, nodes or other computing components may be described as “configured to” perform a task or tasks. Configured to shall recite structure meaning “having circuitry that” performs the task or tasks on operation. The units, circuits, entities, nodes or other computing components can be configured to perform the task even when the unit/circuit/component is not operating. The units, circuits, entities, nodes or other computing components that form the structure corresponding to “configured to” may include hardware circuits and/or memory storing program instructions executable to implement the operation. The units, circuits, entities, nodes or other computing components may be described as performing a task or tasks, for convenience in the description. Such descriptions shall be interpreted as including the phrase “configured to.” Any recitation of “configured to” is expressly intended not to invoke 35 U.S.C. § 112 (f) interpretation.

In general, the methods, apparatuses, systems, computer elements, nodes or other computing components described herein may include memory, software components and hardware components. The memory can include volatile memory such as static or dynamic random-access memory and/or nonvolatile memory such as optical or magnetic disk storage, flash memory, programmable read-only memories, etc. The hardware components may include any combination of combinatorial logic circuitry, clocked storage devices such as flops, registers, latches, etc., finite state machines, memory such as static random-access memory or embedded dynamic random-access memory, custom designed circuitry, programmable logic arrays, etc.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, method steps, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as signal processing devices, and other devices.

A processor may be a processor of any suitable type, and is preferably a processor configured for parallel processing of at least a hundred or at least a thousand threads in parallel, e.g. a graphical processing unit (GPU). For instance, the processor comprises at least a hundred or a at least a thousand parallel processing cores. In particular, the processor may comprise at least one (preferably at least a thousand) compute unified device architecture (CUDA) core(s), which may allow for using a graphical processing unit as the processor, which may increase computational efficiency. For instance, the processor may comprise at least one (e.g. at least a hundred) streaming multiprocessor cores, which may allow for increasing the data throughput. As a further example, the processor may comprise one or more (e.g. at least a hundred) tensor core(s) and/or (e.g. at least a hundred) tensor processing units (TPUs). A tensor core may be specifically adapted to perform matrix operations and may allow to accelerate large matrix operations. A tensor core may be configured to perform mixed-precision matrix multiply and accumulate calculations in a single operation. For instance, a tensor core may perform mixed-precision floating-point matrix arithmetic, specifically utilizing FP16 (half-precision) inputs to produce either full-precision (FP32) or half-precision (FP16) outputs. In the case of FP16 output, a tensor core may provide a performance boost by storing the intermediate accumulation results in FP32 format, thereby maintaining the precision necessary for accurate results. A tensor processing unit may be an application-specific integrated circuit (ASIC). It may comprise a matrix multiplication unit (MXU), which may be specifically adapted or configured for dense linear algebra operations. TPUs may be configured to handle large-scale matrix operations efficiently, which may provide high computational throughput for AI tasks. A TPU may be equipped with on-chip high-bandwidth memory (HBM), which may enhance the capability for the use of larger models and batch sizes. TPUs may be connected in groups called Pods, which may scale up workloads with minimal code changes. An MXU may be specifically configured for performing matrix multiplications. A TPU may comprise a tensor core.

For example, a processor may comprise several thousand tensor cores, each capable of performing 64 floating point FMA (Fused Multiply-Add) operations per clock cycle or (e.g. at least several hundred) tensor processing units (TPUs) being specifically configured for accelerating machine learning (ML) workloads, particularly for cloud-based applications. Additionally, Field-Programmable Gate Arrays (FPGAs) and Application-Specific Integrated Circuits (ASICs) may provide flexibility and performance benefits for specific AI tasks. With these capabilities, such a GPU may allow for hundreds of TFLOPs (Tera Floating-Point Operations per Second) of performance in mixed-precision computations. Furthermore, a tensor core may support a variety of numerical formats, including IEEE standard half-precision, single-precision, and double-precision floating-point formats, as well as a range of integer formats.

A processor may be a central processing unit (CPU) configured with an advanced architecture, such as Intel's Xeon Scalable processors or AMD's EPYC series. A CPU may be configured for sequential processing and general-purpose computing. These CPUs may incorporate vector instruction sets, such as AVX-512, to accelerate mathematical computations that may e.g. enhance AI model training and inference. Furthermore, CPUs may integrate AI accelerators i.e. a CPU may be specifically configured for deep learning workloads.

The processor may be coupled to memory having a memory bandwidth of at least a hundred gigabytes per second, which may allow efficient handling of extensive data sets and may allow faster reading, processing, and writing compared to a general-purpose processor such as a computational processing unit.

The memory may be a high-capacity memory configured to manage the data-intensive nature of AI applications, providing necessary bandwidth and storage capacity for complex datasets. The memory may for instance be DDR4, DDR5, High Bandwidth Memory (HBM) and/or GDDR6X memory, which may improve data transfer rates and reduce latency. Such memory may enhance e.g. modeling and real-time sensor data for monitoring and control. Further, the memory may be operated with memory optimization techniques, such as caching and prefetching, which may enhance the execution speed of AI algorithms. Non-volatile Memory (NVM) technologies, including NAND Flash and 3D XPoint, may provide persistent storage solutions with high-speed access, which may enhance rapid data storage and retrieval for AI applications.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning if not indicated otherwise.

It will be understood that all presented embodiments are only examples, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (e.g. method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

What is claimed is:

1. A method for operating, controlling and/or monitoring a plant comprising:
obtaining a query related to operating at least one chemical apparatus of the plant;
obtaining, based on the query, at least one operation data set comprising data related to operating the at least one chemical apparatus;
determining or obtaining identification data for identifying the at least one operation data set, based on the obtaining the at least one operation data set; and
determining at least one operational data set, the determining the at least one operational data set comprising:
providing a task instruction, based on the query and the at least one operation data set, to at least one multimodal generative data-driven model, the at least one multimodal generative data-driven model having been trained on general purpose training data sets to generate at least one output data set related to operating the at least one chemical apparatus in response to obtaining the task instruction; and
providing the at least one operational data set, wherein the at least one operational data set comprises the at least one output data set and the identification data for identifying the at least one operation data set.

2. The method of claim 1, wherein the at least one operation sequence data set comprises at least a part of the at least one operation data set and/or retrieval data enabling retrieval of the at least one operation data set.

3. The method of claim 1, wherein the at least one operation data set comprises one or more two-dimensional operation representation specific to at least one chemical or industrial process, in particular a chemical or industrial process to be controlled, monitored and/or operated to produce a chemical product.

4. The method of claim 3, wherein the one or more two-dimensional operation representation comprises at least one structured representation of at least one diagram with graphical symbols representing at least the at least one chemical apparatus.

5. The method of claim 3, wherein the at least one operation data set comprises one or more textual data sets associated with the one or more two-dimensional operation representation.

6. The method of claim 3, wherein the at least one operation data set is associated with at least one enriched operation data set comprising or being associated with at least one description or natural language data set related to the one or more operation representation(s), wherein obtaining the at least one operation data set is based on the at least one enriched operation data set.

7. The method of claim 6, wherein the at least one description or natural language data set related to the operation representation is or has been generated by providing a describe task instruction comprising or indicating the one or more operation representation(s) to the at least one multimodal generative data-driven model or another multimodal generative data-driven model, the describe task instruction comprising or indicating an instruction for the at least one multimodal generative data-driven model or the other multimodal generative data-driven model to generate at least one description or natural language data set for the one or more operation representation(s).

8. The method of claim 6, wherein in the at least one enriched operation data set the one or more operation representation(s) have been or are replaced with at least one description or natural language data set.

9. The method of claim 6, wherein obtaining the at least one operation data set is based on a retrieval score of the at least one operation data set, wherein the retrieval score is determined based on one or more of (i), (ii), or (iii):
(i) a similarity score for the operation data set or part thereof based on embedding the operation data set or part thereof and the query into a common embedding space and determining a distance according to a similarity measure between the embedding of the operation data set or part thereof and the embedding of the query;
(ii) a keyword score for the operation data set or part thereof, e.g. based on the number of elements related to the same operation of the plant as indicated in the retrieval instruction;
(iii) a context score for the operation data set or part thereof, e.g. based on a number of same context data sets of the operation data set and the user instruction, pre-processed user instruction, or retrieval instruction.

10. The method of claim 1, wherein the method further comprises:
monitoring, operating and/or controlling the plant based on the at least one operational data set, in particular to produce a chemical product.

11. The method of claim 1, wherein the task instruction comprises an indication of the at least one operation data set and/or at least a part of the at least one operation data set.

12. The method of claim 1, wherein the query comprises natural language, comprising a number of terms, and at least one term associated with the chemical apparatus, another apparatus or a chemical in the query is replaced or expanded using a pre-prepared mapping of the term to further information data on the chemical apparatus, the other apparatus, or the chemical resulting in a pre-processed query; and wherein the obtaining the at least one operation data set is based on the pre-processed query; and wherein the providing the task instruction is based on the pre-processed query.

13. The method of claim 1, wherein the task instruction comprises an instruction to include information data on safety risks and/or pitfalls related to operating the at least one chemical apparatus.

14. A method for producing at least one chemical product, wherein the chemical product is produced by a plant or a chemical production network, the method comprising:
obtaining one or more input material(s);
obtaining a query related to operating at least one chemical apparatus of the plant or chemical production network;
obtaining, based on the query, at least one operation data set comprising data related to operating the at least one chemical apparatus, the product and/or the one or more input material(s);
determining or obtaining identification data for identifying the at least one operation data set, based on the obtaining the at least one operation data set;
determining at least one operational data set, the determining the at least one operational data set comprising: providing a task instruction, based on the query and the at least one operation data set, to at least one multimodal generative data-driven model;
providing the at least one operational data set, wherein the at least one operational data set comprises the at least one output data set and the identification data for identifying the at least one operation data set; and
producing the at least one chemical product based on the at least one operational data set.

15. An apparatus comprising at least one processor and at least one memory storing instructions that, when executed by the at least one processor, cause the apparatus at least to carry out the steps of the method according to claim 1.
